(19) United States
(12) Patent Application Publication
(10) Pub. No.: US 2016/0292726 A1
(43) Pub. Date: Oct. 6, 2016

(54) UNIQUE USER EXPERIENCES IN A CLIENT CONFIGURATION PLATFORM

(71) Applicant: Maritz Holdings Inc., Fenton, MO (US)

(72) Inventors: Scott Wayne Allred, Wildwood, MO (US); Jane Dorothy Chickey, St. Louis, MO (US); James P. Slattery, St. Louis, MO (US); Jennifer Lynn Hunter, St. Louis, MO (US)

(21) Appl. No.: 15/085,611

(22) Filed: Mar. 30, 2016

Related U.S. Application Data
(60) Provisional application No. 62/140,851, filed on Mar. 31, 2015.

(51) Int. Cl. G06Q 30/02; G06Q 30/06; G06F 17/30

(52) U.S. Cl. CPC G06Q 30/0253; G06F 17/30312; G06Q 30/0641

(57) ABSTRACT

Generating a unique client configuration unit (CCU) program user interface for each participant user device. A CCU program generator module generates each CCU program, which is defined by attributes and rules selected via an administrator user interface (AUI). The CCU program is optionally defined by personalization, marketing, and/or targeting rules. A participant user interface (PUI) module identifies participant user devices of the CCU programs and provides identified participant user devices access to their unique CCU program. A processor executes processor-executable instructions comprising the AUI module, the PUI module, and the CCU program generator module to generate the CCU program of each identified participant user device.

### BACKGROUND

Loyalty and reward program management systems provide offerings to participants of the program through user devices. Conventional systems and methods are one-size-fits-all approaches that provide the same offerings to every participant of a program. In addition, global changes across multiple programs require each program to be individually changed. Conventional systems and methods also rely on a human (e.g., a business user) to manually create sites, programs, catalogs, prices, segments, and targeters.

There is a need for a system and method which provides the development, management, and editing of multiple programs while providing custom offerings for each participant via a user device.

### SUMMARY

A system and method including an administrator user interface (AUI) module configured to define a plurality of Client Configuration Unit (CCU) programs in response to administrator input. Each CCU program is defined by a selected attribute subset of the CCU attributes selected in response to administrator input and defined by a selected business rules subset of the business rules selected in response to administrator input. The CCU programs have different attributes subsets and the plurality of CCU programs have different business rules subsets. An e-commerce system is configured to provide access to a plurality of e-commerce websites. The AUI module is also configured to implement in response to administrator input one or more personalization, marketing, and/or targeting rules applicable to the CCU programs. A participant user interface (PUI) module identifies participants of the CCU programs and provides identified participants access to their CCU program. A CCU program generator module configured to generate the CCU program for each of the participants. A processor executes the AUI module, the PUI module, and the CCU program generator module to generate the CCU program of each identified participant.

Other objects and features will be in part apparent and in part pointed out hereinafter.

### BRIEF DESCRIPTION OF THE DRAWINGS AND APPENDIX

FIG. 1 illustrates an exemplary system 10 within which an embodiment of the invention may be incorporated.

FIG. 2 illustrates an exemplary architecture of a computing device programmed to provide aspects of a system 100 according to an embodiment of the invention.

FIG. 3 illustrates a system 100 and computer implemented method according to one embodiment for the efficient configuration and management of multiple, unique e-commerce website experiences from a single portal, source or base catalog.

FIG. 4 is a block diagram showing individuals accessing various e-commerce websites via a portal which configures their website access based on attributes of their CCU program.

FIGS. 5A and 5B depict the items that can be prohibited or added by exclusion and inclusion rules.

FIG. 6 is an example of a hierarchy of exclusion rules.

FIG. 7 depicts one perspective of a flow diagram depicting the generation of a CCU program.

The Appendix illustrates one embodiment of a list of CCU attributes.

Corresponding reference characters indicate corresponding parts throughout the drawings.

### DETAILED DESCRIPTION

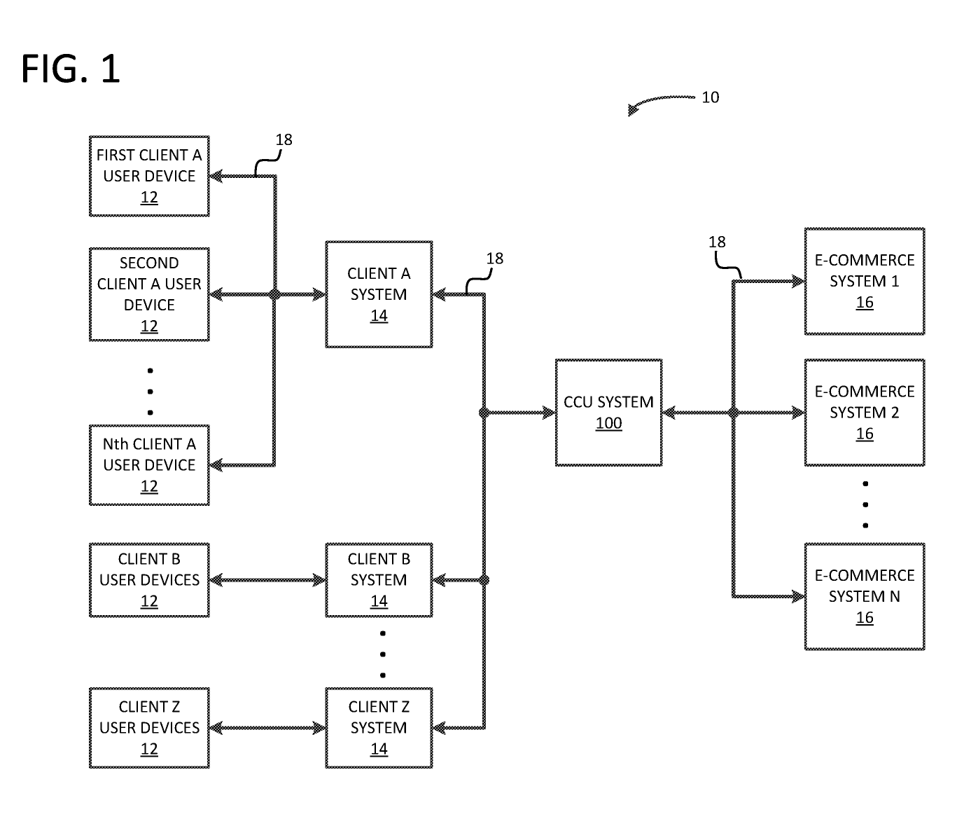

FIG. 1 illustrates an exemplary system 10 within which an embodiment of the invention may be incorporated. The system 10 includes user devices 12, client systems 14, a Client Configuration Unit (CCU) system 100, e-commerce systems 16, and a communication infrastructure 18. In system 10, the user devices 12 are communicatively connected to the client systems 14 via the communication infrastructure 18, client systems 14 are communicatively connected to the CCU system 100 via communication infrastructure 18, and CCU system 100 is communicatively connected to the e-commerce systems 16 via the communication infrastructure 18.

The user devices 12 are adapted to provide access to at least aspects of client systems 14, CCU system 100, and/or e-commerce systems 16. In an embodiment, user devices 12 are computing devices that include a graphical user interface (GUI) adapted to facilitate interaction with client systems 14, CCU system 100, and/or e-commerce systems 16. The user devices 12 may be any computing device capable of executing processor-executable instructions including, but not limited to, personal computers, laptops, workstations, tablets, smartphones, mobile devices, and the like.

The communication infrastructure 18 is capable of facilitating the exchange of data among various components of system 10, including user devices 12, client systems 14, CCU system 100, and e-commerce systems 16. In an embodiment, communication infrastructure 18 includes a local area network (LAN) that is connectable to other telecommunications networks, including other LANs or portions of the Internet or an intranet. The communication infrastructure 18 may be any telecommunications network that facilitates the exchange of data, such as those that operate according to the IEEE 802.3 (e.g., Ethernet) and/or the IEEE 802.11 (e.g., Wi-Fi) protocols, for example. In another embodiment, communication infrastructure 18 is any medium that allows data to be physically transferred through serial and/or parallel communication channels (e.g., copper, wire, optical fiber, computer bus, wireless communication channel, etc.).

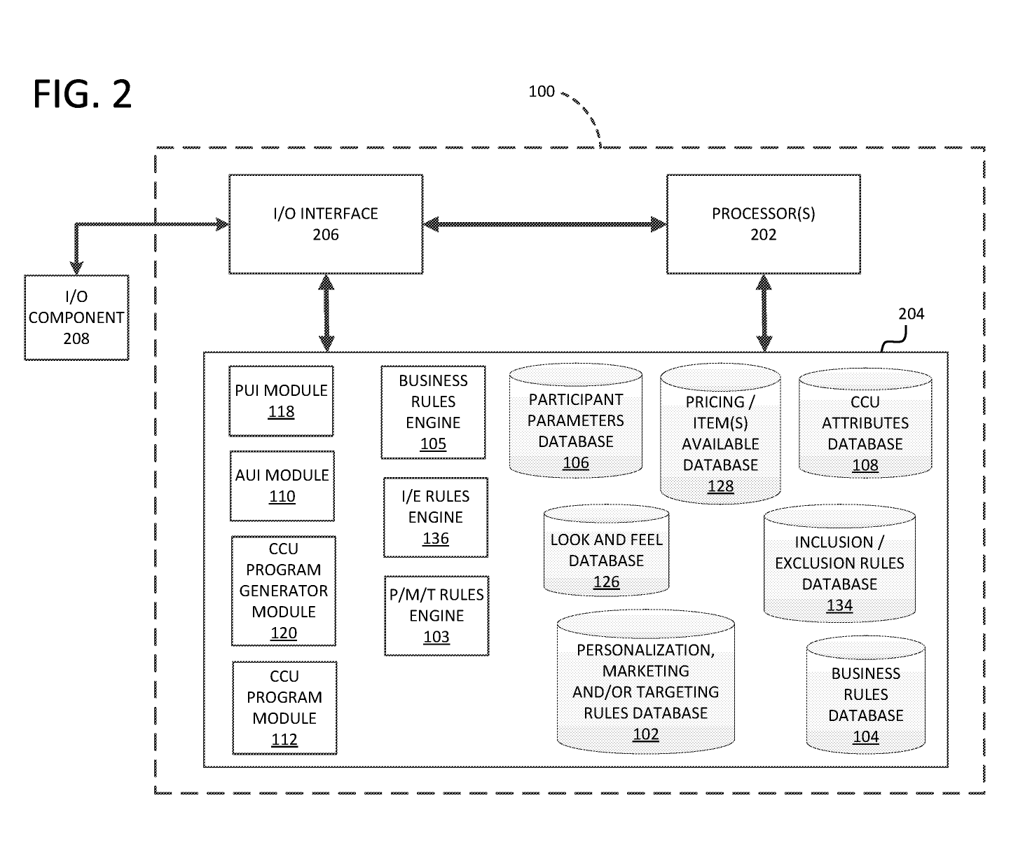

FIG. 2 illustrates an exemplary architecture of CCU system 100. In this embodiment, CCU system 100 includes one or more processors 202, a memory 204, and an input/output (I/O) interface 206 that is adapted to interface with an I/O device 208. The memory 204 includes a personalization, marketing, and/or targeting (P/M/T) rules database 102, a P/M/T rules engine 103, a business rules database 104, a business rules engine 105, a participant parameters database 106, a CCU attributes database 108, an administrator user interface (AUI) software module 110, a CCU program software module 112, a participant user interface (PUI) software module 118, a CCU program generator software module 120, a look and feel rules database 126, a pricing and items available rules database 128, an inclusion/exclusion (I/E) rules database 134, and an I/E rules engine 136.

Referring further to FIG. 2, processor(s) 202, memory 204, and I/O interface 206 are communicatively connected and/or electrically connected to each other. The I/O interface 206 is communicatively and/or electrically connected to I/O device 208. The processor 202 is adapted to execute processor-executable instructions stored in memory 204 for implementing P/M/T rules engine 103, business rules engine 105, AUI software module 110, CCU program software module 112, PUI software module 118, CCU program generator software module 120, and/or TIE rules engine 136.

The I/O interface 206 of FIG. 2 is adapted to provide a data connection between CCU system 100 and I/O device 208. In embodiments of the invention, I/O interface 206 is a network interface card (NIC) or modem and I/O device 208 is a telecommunications network (e.g., communication infrastructure 18). In an embodiment, processor(s) 202 and memory 204 storing the modules, rules engines, and databases comprise one computing device, such as a server computing device. In another embodiment, processor(s) 202 and memory 204 storing the modules, rules engines, and databases comprise one or more computing devices, such as a cloud computing environment.

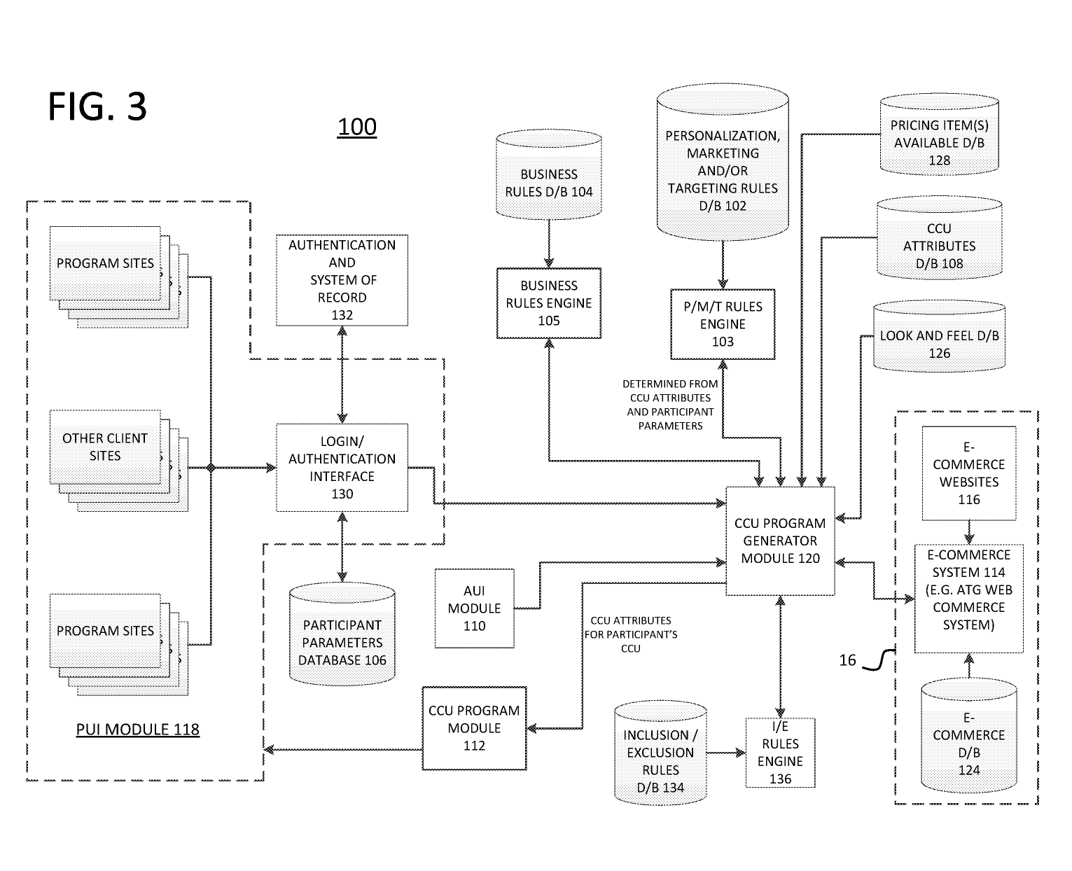

Referring to the embodiment illustrated by FIG. 3, CCU system 100 is adapted to provide a system and/or computer-implemented method for creating, configuring, and/or managing multiple, unique e-commerce website experiences from a single portal, source, or base catalog. The structure and methodology for creating multiple, unique e-commerce website experiences is based on associated Client Configuration Unit (CCU) attributes, such as those stored in CCU attributes database 108. The CCU attributes are characteristics associated with, for instance, a client (e.g., a program owner or operator), a program, and/or the individual within the program. In an embodiment, CCU attributes are characteristics associated with a particular client system 14 (e.g., server computing device) associated with a client. In another embodiment, CCU attributes are characteristics associated with a particular user device 12. The multiple combinations of CCU attributes (e.g., CCU attributes database 108) along with a multiple combination of selected business rules (e.g., business rules database 104) are the basis for generating the unique user experience. For example, CCU attributes may include, but are not limited to, any one or more of: client affiliation, merchandising, marketing, point value, payment method, business rules, and segment.

The system structure and methodology center around CCU program software module 112 generated by CCU program generator software module 120 executed by processor(s) 202 (e.g., one or more server devices, such as a staging server) for configuring and managing the CCU program 112 in accordance with multiple CCU attributes as selected by the client via one or more client systems 14. In an exemplary embodiment, CCU attributes database 108 includes a collection of attributes (e.g., a profile) for each client comprised of selected CCU attributes defining an instance of CCU program software module 112 to be accessed by user devices 12 via each client system 14. The configuration can be managed by an administrator via administrator user interface (AUI) software module 110 in near-real-time with functional knowledge. In an embodiment, AUI software module is accessed by a user device associated with a particular client system 14. In one form, the CCU Program 112 can reside and execute on a production server device. In an aspect, CCU program 112 is provided as processor-executable instructions that comprise a procedure, a function, a routine, a method, and/or a subprogram of CCU system 100.

The AUI software module 110 is adapted to provide an administrator (e.g., utilizing a user device associated with a particular client system 14) access to aspects of CCU system 100 for creating, configuring, and/or managing CCU programs 112. The AUI software module 110 is configured to define a plurality of CCU programs 112 in response to administrator input provided to the administrator by the client running the program. In an aspect, AUI software module 110 is provided as processor-executable instructions that comprise a procedure, a function, a routine, a method, and/or a subprogram of CCU system 100.

It is possible that a participant is participating in several CCU programs 112. Such participants would have a unique log-in for each program and would be presented to only one program at a time, based on the log-in information corresponding to the program. However, it is contemplated that the parameters of such a participant could be shared across some or all the CCU programs 112 in which the participant is a member. For example, the participant's audience segment would be available to some or all of the participant's programs so that content consistent with the participant's segment would be presented to the participant. In one configuration, each participant is a standalone entity even if the same person in several programs. All of the participant's data is stored completely separate from each other for each program. For example, a home address would be the same in all programs but is actually stored separately for each program. Alternatively, it is contemplated that programs share some information about a participant, although this would have to be closely managed with certain approvals and privacy safeguards.

The AUI module 110 is configured to control the plurality of e-commerce websites 116 available to participants via their CCU programs 112. An e-commerce system 114 such as the e-commerce system is configured to provide access to a plurality of e-commerce websites 116. The administrator via the AUI module 110 as executed by the processor(s) 202 interfaces with the e-commerce system 114 to link each CCU program 112 to various e-commerce websites 116, which links are stored in a e-commerce database storage device 124.

The AUI module 110 is additionally configured to implement one or more marketing rules stored in database 102 and selected by the administrator via the AUI module 110 and applicable to the CCU programs 112. Some of the selected marketing rules are selected according to client preferences and some of the marketing rules are selected according administrative preferences and campaigns which an administrator can implement across one or more CCU programs 112. For example, the structure of the system and method provide the ability to report out (in a spreadsheet such as Excel™) to clients to provide a tool for driving business decisions in marketing.

Similarly, the AUI module 110 is additionally configured to implement one or more personalization rules stored in database 102 and selected by the administrator via the AUI module 110 and applicable to the CCU programs 112. Some of the selected personalization rules are selected according to client preferences and some of the personalization rules are selected according administrative preferences and campaigns which an administrator can implement across one or more CCU programs 112.

Similarly, the AUI module 110 is additionally configured to implement one or more targeting rules stored in database 102 and selected by the administrator via the AUI module 110 and applicable to the CCU programs 112. Some of the selected targeting rules are selected according to client preferences and some of the targeting rules are selected according administrative preferences and campaigns which an administrator can implement across one or more CCU programs 112.

The AUI module 110 is additionally configured to implement one or more site look and feel rules stored in database 126 and selected by the administrator via the AUI module 110 and applicable to the CCU programs 112. Some of the selected site look and feel rules are selected according to client preferences and some of the site look and feel rules are selected according administrative preferences and campaigns which an administrator can implement across one or more CCU programs 112.

Similarly, the AUI module 110 is additionally configured to implement one or more pricing and item(s) available rules stored in database 128 and selected by the administrator via the AUI module 110 and applicable to the CCU programs 112. Some of the selected pricing and item(s) available rules are selected according to client preferences and some of the pricing and item(s) available rules are selected according administrative preferences and campaigns which an administrator can implement across one or more CCU programs 112.

A participant user interface (PUI) software module 118 executed by processor(s) 202 is configured to identify participants of the CCU programs and is configured to provide each identified participant access to their particular CCU program 112 based on the participant's log-in information. For example, the log-in information may include participant parameters, such as those stored in participant parameters database storage device 106. As noted herein, participants can be members of several CCU programs 112 and would have unique log-in information for each program. As part of the PUI module 118, each CCU program 112 is generated for each of the participants by a CCU program generator module 120. Each participant is presented with a log-in/authentication interface 130. After the participant successfully logs in, the processor(s) 202 accesses database 106 to determine the particular parameters of the participant for the particular CCU program 112 in which they have logged in. Participants can access the log-in/authentication interface 130 from various program sites in which the participant participates and/or from other client sites with which the participant is associated. After the participant successfully logs in, the processor(s) 202 accesses database 132 to identify the participant's a system of record (i.e., their point bank) and to provide optional processor authentication. In an aspect, PUI software module 118 is provided as processor-executable instructions that comprise a procedure, a function, a routine, a method, and/or a subprogram of CCU system 100.

The CCU system 100 includes seven databases of information used to generate CCU programs 112 for participants. A P/M/T rules database storage device 102 is configured to store a plurality of marketing rules. A business rules database storage device 104 is configured to store a plurality of business rules. A participant parameters database storage device 106 is configured to store a plurality of participant parameters. A CCU attributes database storage device 108 is configured to store a plurality of CCU attributes. An inclusion/exclusion rules database storage device 134 is configured to store a plurality of inclusion/exclusion rules, as further described herein. A look and feel database storage device 126 is configured to store a plurality of look and feel rules. A pricing and items available database storage device 128 is configured to store a plurality of pricing and items available rules.

In one form, the CCU program generator software module 120 generates an instance of CCU program software module 112 in accordance with one or more P/M/T rules stored in P/M/T rules database 102. For example, CCU program generator software module 120 calls P/M/T rules engine 103 for implementing the personalization, marketing, and/or targeting (P/M/T) rules in database 102 to generate an instance of CCU program software module 112 associated with a particular client. In an aspect, P/M/T rules engine 103 is provided as processor-executable instructions that comprise a procedure, a function, a routine, a method, and/or a subprogram of CCU system 100. In one form, the CCU program generator software module 120 generates an instance of CCU program software module 112 in accordance with one or more business rules stored in business rules in database 104. For example, CCU program generator software module 120 calls business rules engine 105 for implementing the business rules in database 104 to generate an instance of CCU program software module 112 associated with a particular client. In an aspect, business rules engine 105 is provided as processor-executable instructions that comprise a procedure, a function, a routine, a method, and/or a subprogram of CCU system 100. In an embodiment, the rules engines 103, 105 comprise CCU program generator software module 120. It is also contemplated that that the rules engines 103, 105 can be separate from the CCU program generator software module 120. In an aspect, CCU program generator software module 120 is provided as processor-executable instructions that comprise a procedure, a function, a routine, a method, and/or a subprogram of CCU system 100.

The system structure and methodology comprises the CCU program generator module 120, which is a unique tool for use by an administrator via AUI 110. The CCU program generator module 120 interfaces with an e-commerce system 114 (e.g., a web commerce platform, such as Oracle's ATG Web Commerce System) which enables delivery of a personalized online buying experience for each participant by presenting relevant content and merchandizing, personalized search, customized marketing programs, and tailored websites. In an aspect, e-commerce system 114 is provided as processor-executable instructions that comprise a procedure, a function, a routine, a method, and/or a subprogram of CCU system 100.

In accordance with an aspect of the invention, the system structure and methodology functionality simplify development and configuration of attributes that, at least in part, define each CCU program 112. In accordance with another aspect of the invention, the system structure and methodology functionality simplify attribute management, such as creation and termination of attributes. In accordance with a further aspect of the invention, the system structure and methodology functionality simplify the creation of a repository (e.g., business rules database 104) to store multiple platform business rules to enable site and content configuration.

In an embodiment, the CCU system 100 and method comprise a repository for all unique platform business rules and allow for the efficient set-up, management, and editing of complex client sites (or stores). In one form, the system comprises a switchboard in which an administrator creates a unique CCU program 112 (or store) by simply and quickly “throwing the switch” on a series of business rules and attributes implemented by the CCU program generator module 120. This system structure and methodology minimizes and/or eliminates the need for hard-coding new technology that will meet requirements of a client and/or site. In an embodiment, the system structure and methodology enable the creation of a new, unique site more quickly and efficiently than conventional systems and/or methods.

In an aspect, the system structure and methodology functionality prevent inconsistencies among one or more CCU programs 112. For example, a restriction such as preventing several CCU programs 112 from accessing a particular vendor previously available via the e-commerce system 114 can be accomplished by selectively implementing a business rule and/or by selectively modifying an attribute of the program. On the other hand, a restriction such as preventing a particular CCU program 112 from accessing a particular vendor previously unavailable via the e-commerce system 114 can be accomplished by selectively modifying an attribute of the program and/or by selectively modifying a business rule. Alternatively, or in addition, such changes can be accomplished by applying a rule (e.g., a first scenario) or not applying the same rule (e.g., a second scenario).

In another aspect, the system structure and methodology functionality provide the ability to manage a large number of client systems 14 and/or e-commerce websites 116 concurrently (e.g., economies of scale). For example, the CCU system 100 and method are intended to allow one administrator to implement, via AUI module 110, a large number (e.g., 100+) of CCU programs 112, each of which has certain unique aspects and certain shared aspects. In addition, the CCU system 100 is intended to allow the administrator to make global changes, via AUI module 110, to shared aspects of each CCU program 112 and to apply selected personalization, marketing or targeting rules (e.g., rules comprising P/M/T rules database 102) across multiple CCU programs 112.

In yet another aspect, the system structure and methodology functionality provide the ability to query aspects of CCU system 100. Beneficially, querying the data enables AUI module 110 to present information (e.g., via a graphical user interface display) so that an administrator can better understand client configurations for reporting purposes. For example, the administrator can query: “all clients that do not allow promotions” using AUI module 110 to determine which client systems 14 do not allow promotions. These types of global data queries are important so that when making a business decision to (for example) run a promotion, the administrator can better understand the scope and reach of clients (e.g., client systems 14) that will be affected. Queries relating to push communications and any other data in the databases of CCU system 100 are also available.

Each CCU program 112 is defined by a selected attribute subset of the CCU attributes stored in CCU attributes database 108 selected by the administrator via the AUI module 110, selected according to client preferences. The CCU program generator module 120 utilizes the selected attributes to generate each CCU program 112. In addition, each CCU program 112 is defined by a selected business rules subset of the business rules stored in business rules database 104 and selected by the administrator via the AUI module 110, selected according to client preferences. The CCU program generator module 120 utilizes the selected business rules to generate each CCU program 112. At least some of the CCU programs 112 have different attributes subsets and at least some of the CCU programs 112 have different business rules subsets, although some of the CCU programs 112 can have the same or substantially similar subsets. At least some of the CCU programs 112 share some attributes subsets and at least some of the CCU programs 112 share business rules subsets, although some of the CCU programs 112 can mutually exclusive subsets.

The various personalization rules, marketing rules, and targeting rules stored in P/M/T database 102 are selectively applied to participants and CCU programs by the CCU program generator module 120 as determined by the CCU attributes of each particular program 112 and as determined by the participant parameters of each participant accessing the particular program.

Thus, as noted herein, one or more processors 202 are configured to:
execute the AUI module 110 to define the CCU programs 112 in response to administrator input received via the AUI module 110;
execute the PUI module 118 to identify participants of the CCU programs 112 and to provide identified participants (e.g., user devices 12) access to their CCU program 112; and
execute the CCU program generator module 120 to generate the CCU program 112 of each identified participant.

Thus, the generated CCU program 112 for each of the participants is based on the selected subset of CCU attributes stored in the attribute database storage device 108, is based on the selected business rules subset of the business rules stored in the business rules database storage device 104, in based on the parameters of the participant stored in the parameter database storage device 106, and is based on the selected marketing rules stored in the marketing rules database storage device 102 controlling e-commerce websites 116 available to the participant's CCU program 112.

In an aspect, CCU system 100 enables AUI module 110 (e.g., a business user) to configure client programs (e.g., CCU programs 112) to account for unique program management, business rules, pricing, creative features, content, etc. of each client (e.g., client system 14) and/or each participant (e.g., user device 12). In one form, the CCU program 112 is defined by:
Client=Unique identifier for a client and/or client system 14 (Client A, Client B, . . . )
Configuration=Grouping Value of a given point product (Penny Points, Dollar Points, . . . )
Unit=Participant Segment Level (Gold, Silver, . . . )

Three Major Attributes that define this form of CCU Program 112 and make each CCU program 112 unique are:
1. Pricing Strategy—CCU program generator module 120 creating a CCU program 112 defined by the business rules implementing pricing items available from database 128;
2. Catalog Offering—CCU program generator module 120 creating a CCU program 112 defined by the business rules implementing the e-commerce websites 116 available from database 124;
3. Look & Feel—CCU program generator module 120 creating a CCU program 112 defined by the business rules implementing the site look and feel available from database 126.

In an embodiment, the CCU program 112 functionality in this form includes:

Participants can be assigned to only one CCU program 112 once they log-in. For example, a user device 12 is assigned to a particular client system 14 upon logging-in to a session.

Participants can migrate between units (a unit is a tier or segment of the program within the same program) rendered based on the parameters of the participant at the time of login, if the program and configuration values are the same while retaining profile settings and order history. A unit could be a website page (e.g., e-commerce website 116). What makes it unique is that it is rendered specifically for a given participant (e.g., user device 12) in a client program. As a client can have multiple programs (employee recognition, channel incentive, consumer loyalty, safety program, etc.) and a participant could be in all or a select few of the programs, the “unit” will render a website, via CCU program 112, that is specific to that participant program experience.

Attributes to control web site behavior (checkout type, wish list allowed, etc.)

Unique creative aspects and designs that create a client specific look and feel per CCU program 112 (including Logos, Cascading Style Sheets, templates, etc.). Each client will have a specific site creative “look and feel” managed by attributes of the CCU program 112.

Attributes to be used for participant segmentation

Attributes to be used for personalization presented to the participant, such as via user devices 12.

Ability to configure and modify multiple CCU programs 112 together to provide common business rules and marketing strategies

Ability to update simultaneously multiple attributes of multiple CCU programs 112 to allow mass management of programs with minimal labor effort

Ability to duplicate CCU programs 112

Ability to create template CCU programs that are utilized by CCU program generator module 120 to generate unique CCU programs 112 from the template

Ability to search and report on CCU programs 112 by all CCU attributes. As noted herein, the query and reporting functions provide the basis for administrators and/or clients evaluate the data within the system and method and to make decisions based on the data within the system and method.

Capable for using standard publishing process including preview of the e-commerce platform system 114

Existing frameworks of CCU programs 112 can be extended in order to enable the administrator to create/update the CCU program 112 and associate them to sites.

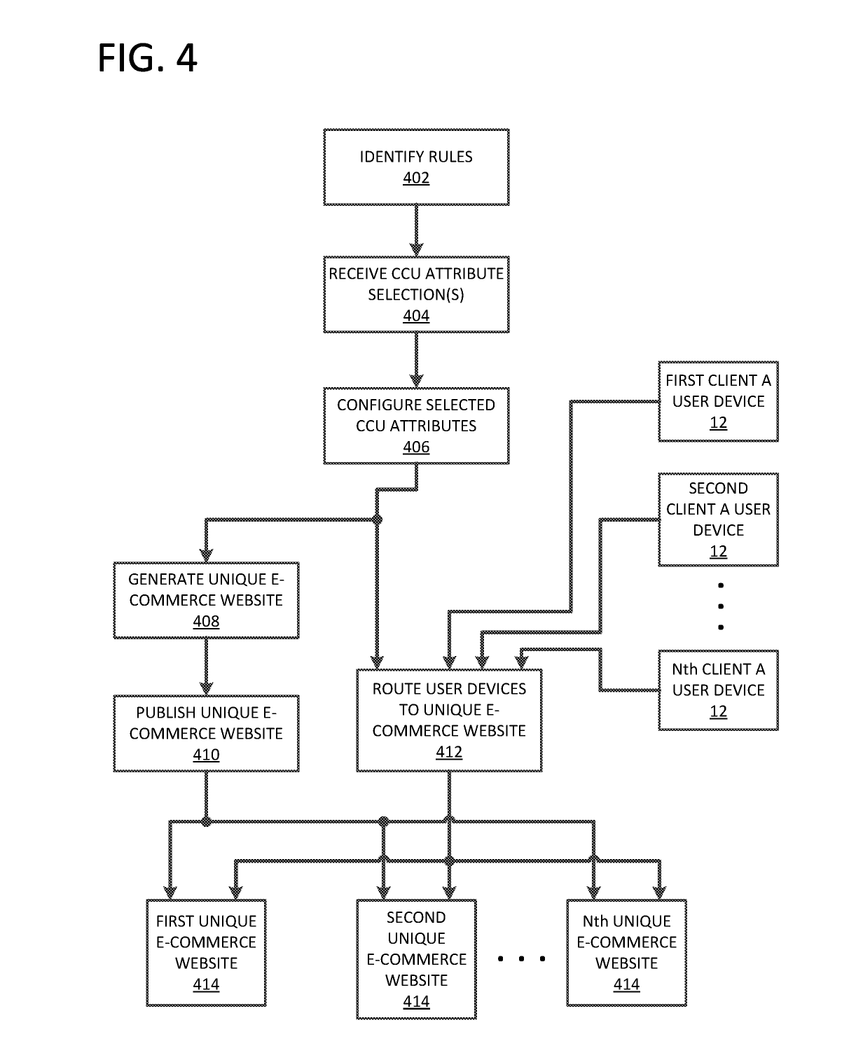

As shown in FIG. 4 in block diagram form, individual user devices 12 access various e-commerce websites 116 via a portal which configures their website access based on attributes of their CCU program 112. The AUI module 110 configures the CCU programs 112 of each client system 14 to provide user devices 12 unique website access. At step 402, aspects of CCU system 100 (e.g., CCU program generator module 120) identify client-specific and program-specific business rules and store them in business rules database 104. In an embodiment, step 402 is referred to as an interpretation phase. At step 404, the business user selects CCU attributes from database 108 through a user interface for a specific client and program. For example, AUI module 110 displays CCU attributes stored in CCU attribute database 108 via a graphical user interface display, receives a selection of the displayed attributes, and transmits the selection(s) to aspects of CCU system 100 (e.g., CCU program generator module 120). In an embodiment, the selection(s) correspond to a particular client system 14. In an embodiment, step 404 is referred to as an application phase.

Referring further to FIG. 4, aspects of CCU system 100 (e.g., CCU program generator module 120) configures selected CCU attributes to create a unique client-specific and program-specific CCU database subset and to create specific program participant routing instructions. In an embodiment, step 406 is referred to as a configuration phase. At step 408, aspects of CCU system 100 (e.g., CCU program generator module 120) generates a unique client-specific and program-specific e-commerce website 116 from the CCU database made up by the unique combination of selected CCU attributes. Aspects of CCU system 100 (e.g., CCU program generator module 120) publishes the unique e-commerce website at step 410. At step 412, aspects of CCU system 100 (e.g., CCU program generator module 120) publish a portal to user devices 12, which then display a portal routing user devices 12 (e.g., users) to unique websites for each client/program based on attributes of their CCU program 112. In an embodiment, steps 408, 410, and/or 412 are referred to as a publication phase. At steps 414, the portal displayed on user devices 12 display the unique e-commerce website for each user device 12. Additionally or alternatively, participants purchase one or more items displayed on the unique e-commerce websites displayed via the portal on user devices 12 via the available e-commerce websites. In an embodiment, steps 414 are referred to as a consumption phase.

There are at least six audience segments that can be used in promotions:

Tech Savvies

Political Mavens

Blogging Moms

Fitness Enthusiasts

Investment Sharks

Fashionistas

Blogging Moms spend considerable time online sharing child rearing tips and recommendations for other online Moms. They create more media content than they consume, and are generally highly emotional when sharing their opinions. Birthday Planning and Celebration are Moms' best ways to express their caring for the loved ones, and make for a great artistic outlet, as does Holiday Shopping. Interest in Sports is driven by Moms' role in planning and supporting their children's sporting activities.

Tech Savvies are up to date on modern technology and the latest gadgets. Savvies enjoy computer hardware and software-related publications, articles, and reviews. Smartphones, Tablets, and Accessories' popularity with the Tech Savvy is not entirely driven by personal necessity—Techies just like to be up to date on the latest mobile devices, which go hand in hand with Operating Systems and Software.

Politics Mavens stay up to date on political news, issues, and elections. They read analysis pieces, opinion pieces, and follow the media on legislative decisions and the status updates on various bills. Politics Mavens tend to take a stand on issues like Green Energy and Solar Power. Politics Mavens are casually but consistently following Investments and Stock Prices, and interested in Financial Trading Solutions.

Fitness Enthusiasts enjoy exercise-related publications. Members like to stay updated on fitness equipment, gear, and industry trends. Enthusiasts are often members of online communities built around tracking individual milestones as well as improving nutrition. Smartphones, Tablets, Accessories, as well as Phone Apps help Fitness Enthusiast track the progress of their Fitness and Nutrition endeavors, and are a reflection of their on-the-go lifestyle.

Investment Sharks follow financial and business news. Sharks track the changes in stock prices and read industry forecasts to inform business and investment decisions. Sharks would not be sharks if they did not follow Investment and Stock Prices topics closely. Interests in Financial and Commodities Trading Solutions and Online Currency Trading follow suit for the same practical reason. Smartphones and Tablets complement Investment Sharks' busy lifestyle.

Fashionistas follow the latest retail trends—often inspired by celebrity style. Fashionistas consume fashion forward & focused publications in addition to periodicals focused on cosmetics, popular culture, and celebrity gossip. Following Pop Music Celebrities is what defines Fashionistas. The only other things Fashionistas spend an equally sizeable amount of time on are Shoes and Apparel. Birthdays and Celebrations are Fashionistas' third favorite pass time, as they get to meet with other like-minded trend-following celebrity fans.

The above six segments are examples of the various audience segments. It should be understood that the number, definition, and content of the segments are not static and will change/evolve over time as new trends are uncovered almost on monthly basis. It is not intended that the segments are set-in-stone for a long period of time. This flexibility in the segments provides the ability to leverage the functionality of the e-commerce system platform 114 and quickly adapt to changing trends and/or market influencers.

In addition, the way a CCU program 112 is constructed and modified via AUI module 110 allows the administrator to segment using dynamic and static attributes (e.g., attributes stored in CCU attributes database 108) to drive the personalization of each CCU program 112 for each user device 12. A segment could be every participant who shops for a particular product (e.g., tools), which would be a dynamic segment so that the administrator can structure the system and method to show such participants similar products (e.g., grills). Alternatively and in addition, a segment can be defined by the administrator using rules and/or attributes as everyone who has a point balance over $100 in value at the time of login, which would be a static segment, in order to show them particular products (e.g., home goods). The segments listed herein are an example of a baseline segmentation methodology that can be applied and such segments will change as the system and method gather data reflecting more user site activity.

### Audience Segmentation Methodology

Audience Segments are sample groupings of publications which reflect a particular persona, lifestyle, or interest group. An audience segment can provide a quick look into how a topic is being perceived by different groups of social media connoisseurs. An audience segment is not meant to encompass every publication that could be potentially relevant to a group of individuals; rather the segment is meant to be composed of key publications which carry weight in the industry and represent the predominant view of the topic by a particular persona. By using audience segmentation, CCU attributes and business rules personalize and target participants.

In an embodiment, CCU system 100 configures (normal state is 200+ unique sites across 100+ clients) 120+ attributes which are used to create each unique CCU program 112. Table 1 below is an example of 3 sites and a sample cross section of their attributes:

TABLE 1

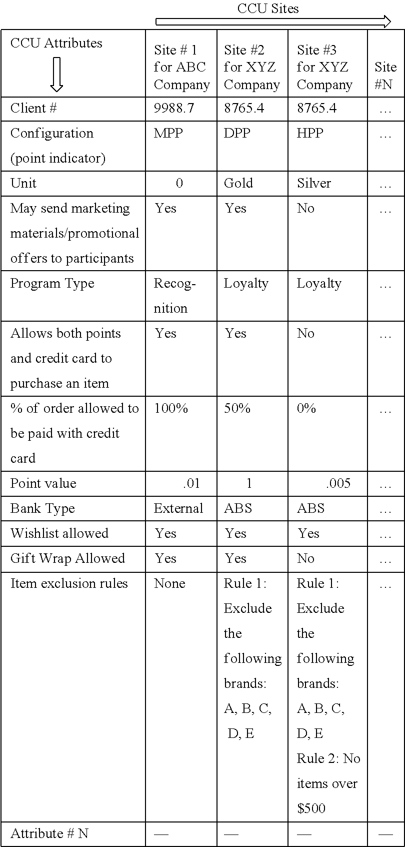

Participant Parameters.

Numerous Parameters apply to an individual participant profile. In an embodiment, participant parameters are associated with a particular user device 12 and/or an account associated with each user device 12. Table 2 below is a cross-section of these Parameters for example participants within the above noted CCU program. Individual CCU programs could have dozens or hundreds of thousands participants:

TABLE 2

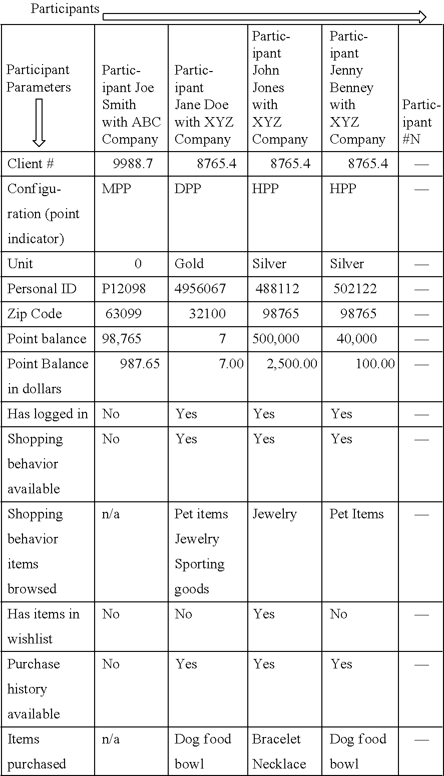

### Scenario 1—Global Rule Updates

Business rules need to be maintained which will affect CCU programs 112 which have certain shared attributes. For example, some items offered in an overall catalog cannot be offered to loyalty clients (e.g., client systems 14 in a loyalty configuration). For example, the item prohibitions may be based on agreements between the administrator and these brand vendors associated with the client systems 14. Thus, a business rule can be created which is assigned to all CCU programs 112 which are loyalty type programs. Exclusion Rule 1 in Table 1 is an exemplary business rule of this type.

Here is an example of this concept: Brand C has formerly declined participation in loyalty program types. The Brand Exclusion rule (noted above) represents all brands, including “C”, which have declined participation in certain program types. Brand C has approached the administrator and has indicated they now wish to participate in all program types. E-commerce systems 114 functionality would allow this via an individual update to each individual site to now include Brand C. CCU program 112 functionality enables the administrator to update the Brand Exclusion rule one time and have it apply to all sites tied to that rule. Thus, sites 2 & 3 in the above example are both affected by the update of one global brand exclusion rule.

### Scenario 2—Segmentation and Marketing

With e-commerce systems 114, each participant (e.g., user device 12) can be marketed to in an individual manner. The challenges to this within the multi-client business model (200+ sites), is to be able to manage the on-going changes to the marketing without incurring an unsupportable amount of labor.

With the CCU program generator module 120 added to e-commerce system 114, administrators are able to dynamically create marketing and targeting at any level of granularity. Any of the 120+ attributes for CCU programs 112 and any of the participant parameters 106 can be combined to create complex targeting rules that will allow targeting both within and across CCU programs 112 with minimal labor.

### Example 1

If an administrator wants to create a segment of all participants who have previously shopped for jewelry, both Jane Doe and John Jones would be included. This segment could then be used to drive specific site content to the user devices 12 of those participants when they log in. The user device 12 of Joe Smith would not receive this offer because it is not known if he is interested in jewelry.

If an administrator then wished to provide a discount to those participants in the jewelry segment, the administrator could include the CCU attribute ‘May send marketing materials/promotional offers to participants’ in the targeting rules and provide both the discount and a banner highlighting that discount on the e-commerce website displayed on each user device 12 of the segment according to each user's CCU program 112. Without the CCU program 112 structure, separate targeting rules would need to be created for each individual site which allowed promotions.

With all the possible combinations between the various CCU attributes 108 and the participant parameters 106 this would become unmanageable in a short period of time.

### Example 2

A mass email can be generated for anyone with a point balance of at least $500 and their client allows marketing to their participants. While both Joe Smith and John Jones each have sufficient balance to be included in the segment, John Jones' sponsoring client does not allow marketing materials to be sent to their participants, thus only Joe Smith would receive the email.

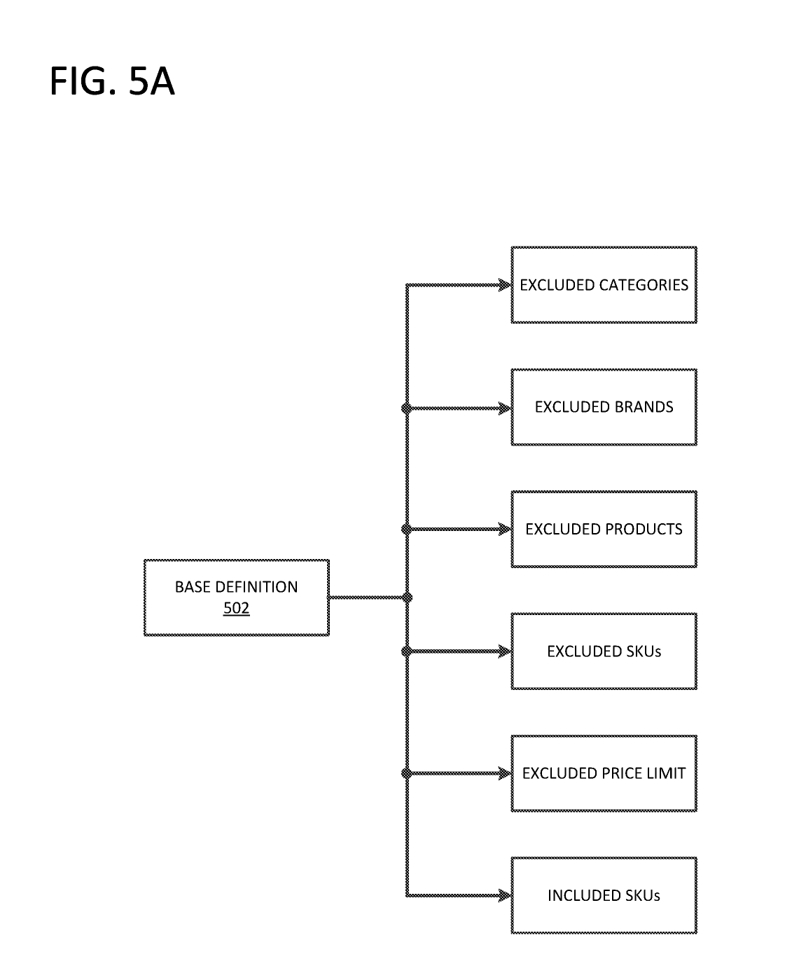

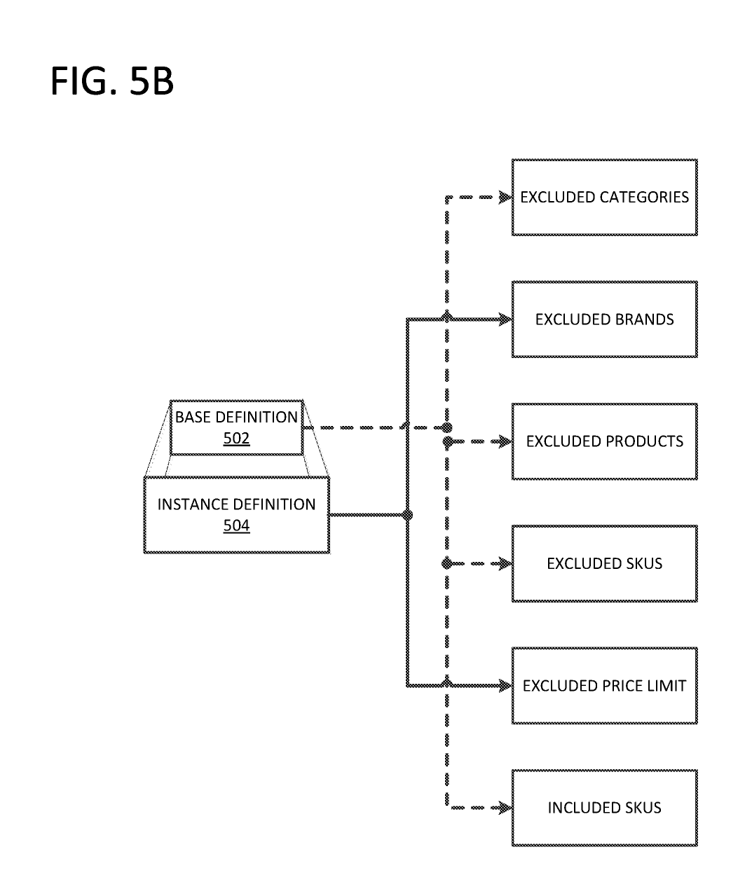

FIGS. 5A and 5B depict the items that can be prohibited or added by exclusion and inclusion rules in a database 134 implemented by I/E rules engine 136. In an aspect, FE rules engine 136 is provided as processor-executable instructions that comprise a procedure, a function, a routine, a method, and/or a subprogram of CCU system 100. As illustrated by FIG. 5A, a base definition 502 (e.g., a reward offer base) can involve: excluded categories, excluded brands, excluded products, excluded SKUs, an excluded price limit, and/or included SKUs, among other items. As shown in FIG. 5B, an instance definition 504 (e.g., a first reward offer) derived from base definition 502 includes excluded brands and an excluded price limit while base definition 502 behind instance definition 504 includes excluded categories, excluded products, excluded SKUs, and included SKUs.

In an embodiment, the administrator has a requirement to maintain exclusion/inclusion rules which contains Exclusion Items and Inclusion Items. These exclusion and inclusion rules are applied while processing the catalog feed specific to a particular CCU program 112. An exclusion/inclusion rule item is defined and linked to CCU attribute Catalog Exclusion Inclusion Rule. The load process in e-commerce system 16 software reads the reward offering exclusion/inclusion rules for the CCU program 112 and generates a list of exclusion rules. Any product or SKU in the load file that matches one of the exclusion rules should be discarded for that CCU program 112.

A catalog load process of CCU system 100 receives a list of products and SKUs for a given CCU program 112. The load consolidates all of the exclusion rules (e.g., from each level of the exclusion hierarchy) and then applies it to the list of products and SKUs. After that, the inclusion rule is applied to add back in any product which was excluded. If the product wasn't in the original feed, it should never be put into the catalog. Inclusion rules are applicable only for products/SKUs that are excluded. For example, if 20 products are configured in exclude products/SKUs and one of them has to be included back to the catalog then inclusion products/SKUs will hold the products/SKUs to be included back.

If a category is configured as excluded category then products or SKUs part of the excluded category can't be included back to the catalog.

Table 3 describes the exclusion/inclusion item properties to be added to the CCU exclusion/inclusion rule property for enabling the business users to define the exclusion and inclusion rules at a CCU program 112 level.

TABLE 3

| | | | BCC | | |
|---|---|---|---|---|---|
| Property name | Data | | Display | | Property |
| in repository | Type | OOTB | Name | BCC Tab Name | Description |
| excludeCategories | List | N | Exclude | CCU>Exclusion/Inclusion | Categories |
| | | | Categories | Catalog> | to be |
| | | | | | excluded |
| excludeProducts | List | N | Exclude | CCU>Exclusion/Inclusion | Products to |
| | | | Products | Catalog> | be excluded |
| excludeSKUs | List | N | Exclude | CCU>Exclusion/Inclusion | SKUs to be |
| | | | SKUs | Catalog> | excluded |
| excludeBrands | List | N | Exclude | CCU>Exclusion/Inclusion | Brands to |
| | | | Products | Catalog> | be excluded |
| excludeMinPrice | Textbox | N | Exclude | CCU>Exclusion/Inclusion | Min price |
| | | | Min Price | Catalog> | of the items |
| | | | | | to be |
| | | | | | excluded |
| excludeMaxPrice | List | N | Exclude | CCU>Exclusion/Inclusion | Max price |
| | | | Products | Catalog> | of the items |
| | | | | | to be |
| | | | | | excluded |
| includeProducts | List | N | Exclude | CCU>Exclusion/Inclusion | Products to |
| | | | Products | Catalog> | be included |
| | | | | | back from |
| | | | | | the |
| | | | | | excluded |
| | | | | | Products |
| includeSKUs | List | N | Exclude | CCU>Exclusion/Inclusion | SKUs to be |
| | | | Products | Catalog> | included |
| | | | | | back from |
| | | | | | the |
| | | | | | excluded |
| | | | | | SKUS |

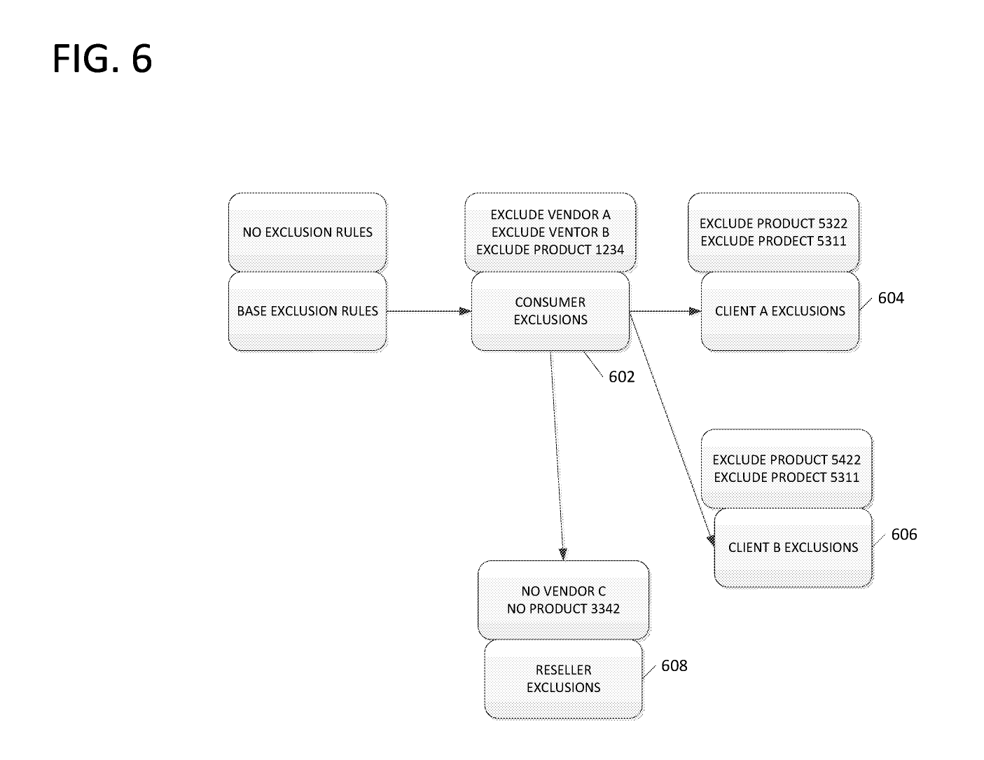

FIG. 6 is an example of a hierarchy of exclusion rules. Any of the illustrated boxes could be assigned to a CCU program. A CCU program 602 with consumer exclusions would contain everything passed in from a prior client program with the exception of vendor A and vendor B branded items and product number 1234. A CCU program 604 with Client A Exclusions contains everything with the exception of product 5322 and product 5311. A CCU program 606 with Client B Exclusions contains everything with the exception of product 5422 and product 5311. A CCU program 608 with Reseller Exclusions contains everything with the exception of Vendor C products and product 3342.

### BCC Product Feed

The administrator can feed two types of catalogs to e-commerce system 114: 1) Deploy Master catalog feed; and 2) Deploy CCU catalog feed. The Master catalog feed and CCU catalog feeds are either auto or manually deployed, as per the deployment configuration defined in the XML. The Master catalog feed will be loaded first, and then the CCU-specific catalog will be loaded and assigned to the site.

Master Catalog—This feed contains the following items, which belong to all the CCUs:
Products
SKUs
Shipping configurations
Shipping and categories
Brands

CCU Catalog—This feed contains the following items related to the specific CCU:
Catalog information
Products
SKUs
Relationships
Navigations
Shipping configurations
Shipping and categories
Brands
CCU specific SKU attributes

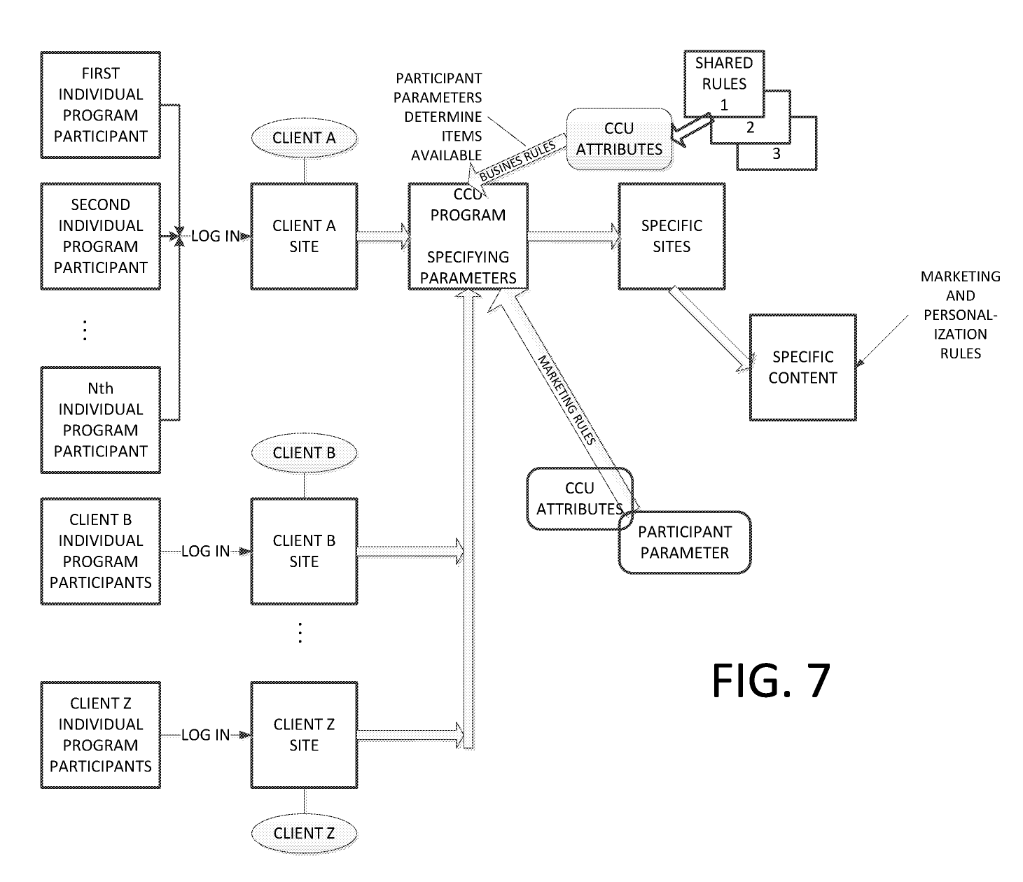

FIG. 7 depicts one perspective of a flow diagram depicting the generation of a CCU program 112. In this diagram, shared rules apply CCU attributes and business rules apply participant parameters to determine items available a participant. The marketing rules are driven by the CCU attributes and the participant parameters. Marketing and personalization rules control the specific site content.

### Functional Requirements

All CCUs are independent, and there is no hierarchy structure or inheritance from one CCU to another.

Business users can create Master CCUs for major program types, which in turn can be used for creating other CCUs using the duplication feature.

The Master Template is a set of attributes used for client setup for reuse by multiple programs. This will be “understood” by business users, and not systemically controlled.

Master CCUs are not meant to have any participants assigned to them. This will be “understood” by business users, and not systemically controlled.

CCU deployment will be done through BCC using the standard e-commerce SYSTEM deployment process. The CCU Administrator will be publishing client setup. It can then be moved to staging, and then to production.

Each CCU has a complete set of attributes for setting up a client.

Participants can only be assigned to one CCU once they log in.

As noted herein, the ability to search using CCU attributes is a key requirement. Functional design sessions focused on CCU as being a repository in the merchandising workbench explained all functionality of merchandising objects; specifically the ability to search and find CCUs by any of their attributes. Additionally, the ability to perform multi-edits is key to managing CCUs.

The Abstract and summary are provided to help the reader quickly ascertain the nature of the technical disclosure. They are submitted with the understanding that they will not be used to interpret or limit the scope or meaning of the claims. The summary is provided to introduce a selection of concepts in simplified form that are further described in the Detailed Description. The summary is not intended to identify key features or essential features of the claimed subject matter, nor is it intended to be used as an aid in determining the claimed subject matter.

For purposes of illustration, programs and other executable program components, such as the operating system, are illustrated herein as discrete blocks. It is recognized, however, that such programs and components reside at various times in different storage components of a computing device, and are executed by a data processor(s) of the device.

Although described in connection with an exemplary computing system environment, embodiments of the aspects of the invention are operational with numerous other special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well-known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the invention may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments of the aspects of the invention may be implemented with processor-executable instructions. The processor-executable instructions may be organized into one or more processor-executable components or modules on a tangible processor readable storage medium which is not a signal. Aspects of the invention may be implemented with any number and organization of such components or modules. For example, aspects of the invention are not limited to the specific processor-executable instructions or the specific components or modules illustrated in the figures and described herein. Other embodiments of the aspects of the invention may include different processor-executable instructions or components having more or less functionality than illustrated and described herein.

The order of execution or performance of the operations in embodiments of the aspects of the invention illustrated and described herein is not essential, unless otherwise specified. That is, the operations may be performed in any order, unless otherwise specified, and embodiments of the aspects of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that several advantages of the aspects of the invention are achieved and other advantageous results may be attained.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively or in addition, a component may be implemented by several components.

The above description illustrates the aspects of the invention by way of example and not by way of limitation. This description enables one skilled in the art to make and use the aspects of the invention, and describes several embodiments, adaptations, variations, alternatives and uses of the aspects of the invention, including what is presently believed to be the best mode of carrying out the aspects of the invention. Additionally, it is to be understood that the aspects of the invention is not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

Having described aspects of the invention in detail, it will be apparent that modifications and variations are possible without departing from the scope of aspects of the invention as defined in the appended claims. It is contemplated that various changes could be made in the above constructions, products, and methods without departing from the scope of aspects of the invention. In the preceding specification, various preferred embodiments have been described with reference to the accompanying drawings. It will, however, be evident that various modifications and changes may be made thereto, and additional embodiments may be implemented, without departing from the broader scope of the aspects of the invention as set forth in the claims that follow. The specification and drawings are accordingly to be regarded in an illustrative rather than restrictive sense.

APPENDIX
CCU ATTRIBUTES

| | | | | | | | | | | | | | | # | |
|---|---|---|---|---|---|---|---|---|---|---|---|---|---|---|---|
| | | | | | | | | | | | | | | Allowed | |
| | | | | BCC | | BCC | | | | | | BCC | | to | |
| | BCC | BCC | BCC | Section | BCC | Attribute | Page/ | | | | | OOTB | | Select | |
| | Display | Tab | Tab | Header | Section | screen | Functionality | Required | | Possible | Default | display | Vali- | in | |
| Attributes: | Name | Sequence | Name | Sequence | Header | sequence | Impacted | Y/N | Length | Values | Value | type | dation | Listbox | Impact on site |
| Client_nbr | Client | 1 | Key | | | 1 | NA | Y | | | | Textbox | | | This is not an auto |
| | Number | | | | | | | | | | | | | | generated number. Part |
| | | | | | | | | | | | | | | | of the CCU unique key |
| Config- | Config- | 1 | Key | | | 2 | NA | Y | | | | Textbox | | | Part of the CCU unique |
| uration_ | uration | | | | | | | | | | | | | | key |
| Indicator | Indicator | | | | | | | | | | | | | | |
| Unit | Unit | 1 | Key | | | 3 | NA | Y | | | | Textbox | | | Combine the values of |
| | | | | | | | | | | | | | | | C, C, U to form the |
| | | | | | | | | | | | | | | | unique identifier and |
| | | | | | | | | | | | | | | | that becomes CCU |
| | | | | | | | | | | | | | | | number for ATG |
| CCU_ | CCU | 1 | Key | | | 4 | Account | Y | | ACTIVE; | | Drop- | | | ACTIVE-all valid |
| Status | Status | | | | | | Management/ | | | READ | | down | | | actions for |
| | | | | | | | SSO/targeting | | | ONLY; | | | | | authenticated user are |
| | | | | | | | | | | INACTIVE | | | | | possible; |
| | | | | | | | | | | | | | | | READ ONLY-Program |
| | | | | | | | | | | | | | | | recently ended. Pax |
| | | | | | | | | | | | | | | | may still log in to view |
| | | | | | | | | | | | | | | | statement and order hist |
| | | | | | | | | | | | | | | | but no add to cart/WL |
| | | | | | | | | | | | | | | | allowed |
| | | | | | | | | | | | | | | | INACTIVE-No login |
| | | | | | | | | | | | | | | | allowed . . . program |
| | | | | | | | | | | | | | | | completely over |
| Base AR | Base AR | 1 | Key | | | 5 | n/a | y | | | | Textbox | | | informational |
| Client | Client # | | | | | | | | | | | | | | |
| Number | | | | | | | | | | | | | | | |
| Projectnbr | Project # | 2 | Base | 1 | Informa- | 1 | NA | Y | | | | Textbox | | | Informational and need |
| | | | Info | | tional | | | | | | | | | | to pass to 1FS during |
| | | | | | | | | | | | | | | | order submission |
| Client_ | Client | 2 | Base | 1 | Informa- | 2 | NA | N | | | | Textbox | | | Informational and no |
| Name | Name | | Info | | tional | | | | | | | | | | impact on ATG site |
| Program_ | Program | 2 | Base | 1 | Informa- | 3 | SSO??/ | Y | | 1 | Recog- | Drop- | | | Informational only. No |
| Type | Type | | Info | | tional | | Targeting/ | | | Incentive | nition | down | | | impact on ATG site |
| | | | | | | | | | | 2. | | | | | |
| | | | | | | | | | | Recognition | | | | | |
| | | | | | | | | | | 3. | | | | | |
| | | | | | | | | | | Channel | | | | | |
| | | | | | | | | | | 4. Gift | | | | | |
| | | | | | | | | | | 5. Gaming | | | | | |
| | | | | | | | | | | 6. Svc | | | | | |
| | | | | | | | | | | Anniv | | | | | |
| | | | | | | | | | | 7. | | | | | |
| | | | | | | | | | | Rewards | | | | | |
| | | | | | | | | | | Direct | | | | | |
| | | | | | | | | | | 8. AHQ | | | | | |
| | | | | | | | | | | Lite | | | | | |
| | | | | | | | | | | 9. Loyalty | | | | | |
| | | | | | | | | | | 10. Demo | | | | | |
| | | | | | | | | | | 11. Pure | | | | | |
| | | | | | | | | | | Fulfillment | | | | | |
| | | | | | | | | | | Only | | | | | |
| | | | | | | | | | | 12. Other | | | | | |
| | | | | | | | | | | 13. Open | | | | | |
| Program_ | Program | 2 | Base | 1 | Informa- | 4 | NA | | | | | Textbox | | | Informational and no |
| Theme | Theme | | Info | | tional | | | | | | | | | | impact on ATG site |
| Contract_ | Contract | 2 | Base | 1 | Informa- | 5 | NA | | | | | Date | | | Informational and no |
| start_date | Start Date | | Info | | tional | | | | | | | | | | impact on ATG site |
| Contract_ | Contract | 2 | Base | 1 | Informa- | 6 | NA | | | | | Date | | | Informational and no |
| end_date | End Date | | Info | | tional | | | | | | | | | | impact on ATG site |
| Point_ | Point | 2 | Base | 1 | Informa- | 7 | NA | | | | | Textbox | | | Informational and no |
| Product_ | Product | | Info | | tional | | | | | | | | | | impact on ATG site |
| Description | Description | | | | | | | | | | | | | | |
| Bank Type | Bank Type | 2 | Base | 1 | Informa- | 8 | NA | Y | | 1. ABS | ABS | Drop- | | | Informational only. No |
| | | | Info | | tional | | | | | 2. ABS CB | | down | | | impact on ATG site |
| | | | | | | | | | | 3 LHQ CB | | | | | |
| | | | | | | | | | | 4 Ext | | | | | |
| | | | | | | | | | | Bank | | | | | |
| | | | | | | | | | | 5 EY | | | | | |
| | | | | | | | | | | 6 Card | | | | | |
| | | | | | | | | | | non EY | | | | | |
| | | | | | | | | | | 7 ABS | | | | | |
| | | | | | | | | | | YRC | | | | | |
| | | | | | | | | | | 8 None | | | | | |
| Sector | Sector | 2 | Base | 1 | Informa- | 9 | NA | | | | | Textbox | | | Informational and no |
| | | | Info | | tional | | | | | | | | | | impact on ATG site |
| Client 800# | Client 800 # | 2 | Base | 1 | Informa- | 10 | NA | N | | | 1-800- | Textbox | | | Informational and no |
| | | | Info | | tional | | | | | | 343-2607 | | | | impact on ATG site |
| Test_QA_ | Test QA | 2 | Base | 1 | Informa- | 11 | NA | | | | | Textbox | | | Informational and no |
| Account_ | Account # | | Info | | tional | | | | | | | | | | impact on ATG site |
| Number | | | | | | | | | | | | | | | |
| Prod_QA_ | Prod QA | 2 | Base | 1 | Informa- | 12 | NA | | | | | Textbox | | | Informational and no |
| Account_ | Account # | | Info | | tional | | | | | | | | | | impact on ATG site |
| Number | | | | | | | | | | | | | | | |
| Allow_ | Allow | 2 | Base | 1 | Informa- | 13 | Shopping | Y | 1 | Y/N | N | Radio | | | Business user creates a |
| Promotions | Promotions | | Info | | tional | | Cart/ | | | | | button | | | segment using this |
| | | | | | | | Promotions | | | | | | | | property to define a |
| | | | | | | | | | | | | | | | particular user group. |
| | | | | | | | | | | | | | | | Segment will be used to |
| | | | | | | | | | | | | | | | set up promotions to |
| | | | | | | | | | | | | | | | apply the promotions to |
| | | | | | | | | | | | | | | | a specific group of |
| | | | | | | | | | | | | | | | users. This segment |
| | | | | | | | | | | | | | | | can be used only in |
| | | | | | | | | | | | | | | | ATG's Adavanced and |
| | | | | | | | | | | | | | | | Conditional Offer |
| | | | | | | | | | | | | | | | promotion template. |
| | | | | | | | | | | | | | | | Promotions defined |
| | | | | | | | | | | | | | | | without this segment |
| | | | | | | | | | | | | | | | gets applied as per |
| | | | | | | | | | | | | | | | OOTB behavior |
| | | | | | | | | | | | | | | | This attribute will also |
| | | | | | | | | | | | | | | | be used to control the |
| | | | | | | | | | | | | | | | display of apply |
| | | | | | | | | | | | | | | | coupons fragment in |
| | | | | | | | | | | | | | | | shopping cart page. If |
| | | | | | | | | | | | | | | | this flag is set Y, apply |
| | | | | | | | | | | | | | | | coupons fragment will |
| | | | | | | | | | | | | | | | be displayed on the |
| | | | | | | | | | | | | | | | shopping cart page. If |
| | | | | | | | | | | | | | | | this flag is set to N, |
| | | | | | | | | | | | | | | | apply coupons fragment |
| | | | | | | | | | | | | | | | will not be displayed on |
| | | | | | | | | | | | | | | | the shopping cart page |
| Allow Push | Allow Push | 2 | Base | 1 | Informa- | 14 | NA | Y | 1 | Y/N | Y | Radio | | | No affect to ATG. Info |
| Commu- | Commu- | | Info | | tional | | | | | | | button | | | only |
| nication | nications | | | | | | | | | | | | | | |
| Catalog_ | Catalog | 3 | Business | 1 | Award | 1 | Catalog Feed | N | | | | Listbox | | Allow | A catalog will be created |
| INCLUDE_ | Include/ | | Rule | | Offer & | | Process/ | | | | | | | multiple | with inclusion & |
| EXCLUE_ | Exclusion | | | | Pricing | | Targeting | | | | | | | | exclusion items. |
| Rule | Rule | | | | | | | | | | | | | | Business will publish |
| | | | | | | | | | | | | | | | these before the CCU |
| | | | | | | | | | | | | | | | feed is processed. ATG |
| | | | | | | | | | | | | | | | to include/exclude the |
| | | | | | | | | | | | | | | | items defined in |
| | | | | | | | | | | | | | | | include/exclusion |
| | | | | | | | | | | | | | | | catalog while |
| | | | | | | | | | | | | | | | processing the CCU |
| | | | | | | | | | | | | | | | feed. This attribute |
| | | | | | | | | | | | | | | | decide which |
| | | | | | | | | | | | | | | | include/exlusion catalog |
| | | | | | | | | | | | | | | | to be selected. Need to |
| | | | | | | | | | | | | | | | discuss on pricelist |
| | | | | | | | | | | | | | | | include/exclusion |
| Point_ | Point | 3 | Business | 1 | Award | 2 | Pricing | Y | Number | | | Textbox | | | ATG to use this property |
| Conversion_ | Conversion | | Rule | | Offer & | | | | 14.8 | | | | | | to convert $ to points in |
| Factor | Factor | | | | Pricing | | | | | | | | | | case required during |
| | | | | | | | | | | | | | | | price calculation. |
| | | | | | | | | | | | | | | | ATG to validate this with |
| | | | | | | | | | | | | | | | the conversion rate |
| | | | | | | | | | | | | | | | coming in from price |
| | | | | | | | | | | | | | | | feed data during feed |
| | | | | | | | | | | | | | | | process |
| Effective_ | Effective | 3 | Business | 1 | Award | 3 | Pricing/ | Y | Number | | | Textbox | | | ATG to use this property |
| Point_ | Point | | Rule | | Offer & | | Checkout | | 14.8 | | | | | | to convert points to $ |
| Conversion_ | Coversion | | | | Pricing | | | | | | | | | | when supplemental |
| Factor | Factor | | | | | | | | | | | | | | payment is to be |
| | | | | | | | | | | | | | | | applied. This conversion |
| | | | | | | | | | | | | | | | to be applied during |
| | | | | | | | | | | | | | | | checkout with credit |
| | | | | | | | | | | | | | | | card as part of |
| | | | | | | | | | | | | | | | supplemental pay |
| Precision_ | Precision | 3 | Business | 1 | Award | 4 | Pricing/ | Y | 5 | | | Textbox | | | dollars converted to |
| Rule | Rule | | Rule | | Offer & | | Checkout | | | | | | | | points should result in a |
| | | | | | Pricing | | | | | | | | | | multiple of this value. To |
| | | | | | | | | | | | | | | | round up during the |
| | | | | | | | | | | | | | | | coversion of $ to points. |
| Effective_ | Effective | 3 | Business | 1 | Award | 5 | Pricing/ | Y | 5 | | | Textbox | | | points converted to |
| Precision_ | Precision | | Rule | | Offer & | | Checkout | | | | | | | | dollars for supplmental |
| Rule | Rule | | | | Pricing | | | | | | | | | | payment should result in |
| | | | | | | | | | | | | | | | a multiple of this value. |
| | | | | | | | | | | | | | | | To round up during the |
| | | | | | | | | | | | | | | | coversion of points to |
| | | | | | | | | | | | | | | | $. |
| POINTS_ | Points or | 3 | Business | 1 | Award | 6 | search | Y | | Points/ | Y | Drop- | | | This attribute controls |
| OR_ | Dollars | | Rule | | Offer & | | results, | | | Dollars | | down | | | whether the site works |
| DOLLARS | | | | | Pricing | | item | | | | | | | | on $ or points based |
| | | | | | | | detail, cart | | | | | | | | pricing model. Price |
| | | | | | | | & Ckout | | | | | | | | need to be displayed |
| | | | | | | | | | | | | | | | across the site with $ |
| Pricing_ | Pricing | 3 | Business | 1 | Award | 7 | Pricing | | | | | Drop- | | | Display of price on ATG |
| Model_ | Model | | Rule | | Offer & | | | | | | | down | | | site will be decided |
| | | | | | Pricing | | | | | | | | | | based on the value of |
| | | | | | | | | | | | | | | | this attribute. Possible |
| | | | | | | | | | | | | | | | values of the attribute |
| | | | | | | | | | | | | | | | are as below. |
| | | | | | | | | | | | | | | | Delsell |
| | | | | | | | | | | | | | | | Itemsell |
| | | | | | | | | | | | | | | | Separated |
| | | | | | | | | | | | | | | | Display of price on this |
| | | | | | | | | | | | | | | | attribute will be covered |
| | | | | | | | | | | | | | | | in PAXII |
| | | | | | | | | | | | | | | | ATG to validate this with |
| | | | | | | | | | | | | | | | the data coming in from |
| | | | | | | | | | | | | | | | price feed data during |
| | | | | | | | | | | | | | | | feed process |
| Tax_Type | Tax Type | 3 | Business | 1 | Award | 8 | Tax/ | | | | | Drop- | | | If this attribute values is |
| | | | Rule | | Offer & | | Shopping | | | | | down | | | ESTIMATED, ATG |
| | | | | | Pricing | | Cart | | | | | | | | picks tax from price list |
| | | | | | | | | | | | | | | | data given in the feed. If |
| | | | | | | | | | | | | | | | this attribute value is |
| | | | | | | | | | | | | | | | ACTUAL, ATG makes |
| | | | | | | | | | | | | | | | real time service call to |
| | | | | | | | | | | | | | | | vertex to get the tax |
| Tax_ | Tax Exempt | 3 | Business | 1 | Award | 9 | Tax/Shopping | Y | 1 | Y/N | N | Radio | | | Informational only |
| exempt | | | Rule | | Offer & | | Cart | | | | | button | | | |
| | | | | | Pricing | | | | | | | | | | |
| Pax_points_ | Points | 3 | Business | 1 | Award | 10 | Account | N | | | Points | Textbox | | | Points text to be |
| text | Label | | Rule | | Offer & | | Management?? | | | | | | | | displayed on the site |
| | Name | | | | Pricing | | Isn't this | | | | | | | | |
| | | | | | | | browse | | | | | | | | |
| | | | | | | | and shop? | | | | | | | | |
| Pax_points_ | Display | 3 | Business | 1 | Award | 11 | Account | Y | 1 | Y/N | Y | Radio | | | Decides whether or not |
| display | Points | | Rule | | Offer & | | Management?? | | | | | button | | | to display the |
| | Label | | | | Pricing | | Isn't this | | | | | | | | “pax_points_text” value |
| | | | | | | | browse | | | | | | | | next to the points |
| | | | | | | | and shop? | | | | | | | | message |
| edit_egift_ | Edit eGift | 3 | Business | 1 | Award | 12 | cart | y | 1 | Y/N | N | Radio | | | During checkout, if the |
| email | Email | | Rule | | Offer & | | | | | | | button | | | order contains any egift |
| | | | | | Pricing | | | | | | | | | | item then system |
| | | | | | | | | | | | | | | | controls whether or not |
| | | | | | | | | | | | | | | | email address can be |
| | | | | | | | | | | | | | | | editable in item |
| | | | | | | | | | | | | | | | customizations page |
| ReDEMP- | Client Order | 3 | Business | 1 | Award | 13 | Checkout | N | | .00-$999 | 0 | Textbox | | | pass with order . . . no |
| TION_ | Fee | | Rule | | Offer & | | | | | | | | | | impact on order amt |
| FEE_ | | | | | Pricing | | | | | | | | | | |
| AMOUNT_ | | | | | | | | | | | | | | | |
| CLIENT | | | | | | | | | | | | | | | |
| REDEMP- | Pax | 3 | Business | 1 | Award | 14 | Checkout | | | | | Textbox | | | This will be set up in $ |
| TION_ | Redemption | | Rule | | Offer & | | | | | | | | | | and need to convert to |
| FEE_ | Fee | | | | Pricing | | | | | | | | | | points using CCUpoint |
| AMOUNT_ | Amount | | | | | | | | | | | | | | conversion factor. Order |
| PAX | in $ | | | | | | | | | | | | | | fees to be paid on order |
| | | | | | | | | | | | | | | | total. Refer PAM |
| Browse_ | Display | 3 | Business | 1 | Award | 15 | Pricing | Y | 1 | Y/N | | Radio | | | If pax is tagged as |
| price_ | Price in | | Rule | | Offer & | | | | | | | button | | | “browse only” during |
| display | Browse | | | | Pricing | | | | | | | | | | login, this flag indicates |
| | | | | | | | | | | | | | | | if pricing for items |
| | | | | | | | | | | | | | | | should appear or not |
| Can_ship_ | Can Ship | 3 | Business | 2 | Pax | 1 | Account | | 1 | Y/N | | Radio | | | User has option to use |
| to_source_ | To Source | | Rule | | Attributes | | Management/ | | | | | button | | | this address or add new |
| address | Address | | | | | | Checkout | | | | | | | | address if this is Y. Not |
| | | | | | | | | | | | | | | | REQUIRED to use this |
| | | | | | | | | | | | | | | | address unless “can |
| | | | | | | | | | | | | | | | ship to alt address” Is N |
| Display_ | Dispaly | 3 | Business | 2 | Pax | 2 | Account | | 1 | Y/N | | Radio | | | ATG to display the |
| Source_ | Source | | Rule | | Attributes | | Management/ | | | | | button | | | source address if this |
| address | Address | | | | | | Checkout | | | | | | | | |
| | | | | | | | | | | | | | | | flag is set to Y If N then |
| | | | | | | | | | | | | | | | can ship to source |
| | | | | | | | | | | | | | | | address must be N |
| Edit_ | Can Edit | 3 | Business | 2 | Pax | 3 | Account | | 1 | Y/N | | Radio | | | ATG to allow the user to |
| source_ | Source | | Rule | | Attributes | | Management/ | | | | | button | | | edit the source address |
| address | Address | | | | | | Checkout | | | | | | | | if this flag is set to Y. |
| | | | | | | | | | | | | | | | This attribute can be set |
| | | | | | | | | | | | | | | | Y only if |
| | | | | | | | | | | | | | | | Can_ship_to_source_ad |
| | | | | | | | | | | | | | | | dress is Y |
| Can_ship_ | Alternate | 3 | Business | 2 | Pax | 4 | | | 1 | Y/N | | Radio | | | If “can ship to source |
| to_alt_ | Address | | Rule | | Attributes | | | | | | | button | | | address is “N” this must |
| address | Allowed | | | | | | | | | | | | | | be “Y”. Only show alt |
| | | | | | | | | | | | | | | | address option if this is |
| | | | | | | | | | | | | | | | Y |
| May_ | May | 3 | Business | 2 | Pax | 5 | Account | | 1 | Y/N | | Radio | | | ATG to allow PAX to |
| Update_ | Update | | Rule | | Attributes | | Management/ | | | | | button | | | update profile's phone |
| phone | Phone | | | | | | Checkout | | | | | | | | number if this flag is set |
| | | | | | | | | | | | | | | | to Y. This validation is |
| | | | | | | | | | | | | | | | required in my account |
| | | | | | | | | | | | | | | | page and checkout |
| | | | | | | | | | | | | | | | pages |
| May_ | May | 3 | Business | 2 | Pax | 6 | Account | | 1 | Y/N | | Radio | | | ATG to allow PAX to |
| Update_ | Update | | Rule | | Attributes | | Management/ | | | | | button | | | update profile's email |
| email | Email | | | | | | Checkout | | | | | | | | address if this flag is set |
| | | | | | | | | | | | | | | | to Y. This validation is |
| | | | | | | | | | | | | | | | required in my account |
| | | | | | | | | | | | | | | | page and checkout |
| | | | | | | | | | | | | | | | pages |
| May_ | May | 3 | Business | 2 | Pax | 7 | Account | | 1 | Y/N | | Radio | | | ATG to allow PAX to |
| Update_ | Update | | Rule | | Attributes | | Management/ | | | | | button | | | update profile's name |
| Name | Name | | | | | | Checkout | | | | | | | | properties if this flag is |
| | | | | | | | | | | | | | | | set to Y. This validation |
| | | | | | | | | | | | | | | | is required in my |
| | | | | | | | | | | | | | | | account page and |
| | | | | | | | | | | | | | | | checkout pages |
| Email_ | Email | 3 | Business | 2 | Pax | 8 | Account | | 1 | Y/N | | Radio | | | If this flag is set to Y, |
| Mandatory | Mandatory | | Rule | | Attributes | | Management/ | | | | | button | | | ATG to allow the FAX to |
| | | | | | | | Checkout | | | | | | | | place the order only if |
| | | | | | | | | | | | | | | | email address exists |
| Login_ | Login Type | 3 | Business | 2 | Pax | 9 | Login | Y | | None | Internal | Drop- | | | Informational and no |
| Type | | | Rule | | Attributes | | | | | User | blind pass | down | | | impact on ATG site |
| | | | | | | | | | | name | | | | | |
| | | | | | | | | | | required | | | | | |
| | | | | | | | | | | Internal | | | | | |
| | | | | | | | | | | blind pass | | | | | |
| | | | | | | | | | | External | | | | | |
| | | | | | | | | | | Bank | | | | | |
| | | | | | | | | | | Other | | | | | |
| UNPW_ | Has UN & | 3 | Business | 2 | Pax | 10 | Acct Mgt | Y | 1 | Y/N | N | Radio | | | if Y and pax is |
| REQUIRED | PW | | Rule | | Attributes | | | | | | | button | | | authenticated, display |
| | | | | | | | | | | | | | | | “edit UN/PW” link in |
| | | | | | | | | | | | | | | | Acct and send token to |
| | | | | | | | | | | | | | | | AHQ |
| Supple- | Supple- | 3 | Business | 3 | Checkout | 1 | Checkout | Y | 3 | | | Textbox | | | This attributes decides |
| mental_ | mental | | Rule | | | | | | | | | | | | the allowable |
| Pay_% | Pay% | | | | | | | | | | | | | | percentange to |
| | | | | | | | | | | | | | | | purchase the item with |
| | | | | | | | | | | | | | | | credit card |
| Max Order | Max Order | 3 | Business | 3 | Checkout | 2 | cart/ | Y | | 1-99 | 99 | Textbox | | | Total qty of cart should |
| Qty | Qty | | Rule | | | | checkout | | | | | | | | not exceed this value |
| Payment_ | Payment | 3 | Business | 3 | Checkout | 3 | Checkout | Y | 10 | | | Listbox | at least | multiple | Need to control the |
| Type | Type | | Rule | | | | | | | | | | one | allowed | payment options to be |
| | | | | | | | | | | | | | pmt | | displayed on the |
| | | | | | | | | | | | | | type | | checkout pages of ATG |
| | | | | | | | | | | | | | must | | site for point payments |
| | | | | | | | | | | | | | be | | and supplemental |
| | | | | | | | | | | | | | saved | | payment types |
| | | | | | | | | | | | | | per | | |
| | | | | | | | | | | | | | CCU | | |
| Checkout | Checkout | 3 | Business | 3 | Checkout | 4 | Checkout | | | | | Textbox | | | If populated, AVON- |
| PAX Id | PAX | | Rule | | | | | | | | | | | | display the dealer rep id |
| | IdLabel | | | | | | | | | | | | | | in checkout page. In |
| | | | | | | | | | | | | | | | case of casino |
| | | | | | | | | | | | | | | | checkout, during add |
| | | | | | | | | | | | | | | | address display the |
| | | | | | | | | | | | | | | | player club id |
| Style Sheet | | 4 | Site | 1 | Content | 1 | | | | | | Textbox | | | Style sheet file to be |
| | | | Config | | | | | | | | | | | | used to web site |
| Mobile Style | | 4 | Site | 1 | Content | 2 | | | | | | Textbox | | | Style sheet file to be |
| Sheet | | | Config | | | | | | | | | | | | used for mobile site |
| Site | Site | 4 | Site | 1 | Content | 3 | Homepage | Y | | | | Listbox | | only | Listbox contains values |
| Refresh | Refresh | | Config | | | | | | | | | | | allow | such as Monthly, |
| Strategy | Strategy | | | | | | | | | | | | | one to | Weekly etc. These |
| | | | | | | | | | | | | | | be | values should be |
| | | | | | | | | | | | | | | selected | configurable through |
| | | | | | | | | | | | | | | | BCC. May need to fill for |
| | | | | | | | | | | | | | | | each slot/targeter. This |
| | | | | | | | | | | | | | | | attribute will be used in |
| | | | | | | | | | | | | | | | segmentation/targeting |
| Other Notes | | 4 | Site | 1 | Content | 4 | | | | | | Textbox | | | Informational only. No |
| | | | Config | | | | | | | | | | | | impact on ATG site |
| Login_URL | Login URL | 4 | Site | 1 | Content | 5 | Login | Y | | | | Textbox | | | ATG to redirect to the |
| | | | Config | | | | | | | | | | | | login URL given in this |
| | | | | | | | | | | | | | | | attribute |
| Logo_URL | Logo URL | 4 | Site | 1 | Content | 6 | Homepage | Y | | | | Textbox | | | This attributes decides |
| | | | Config | | | | | | | | | | | | the logo to be displayed |
| | | | | | | | | | | | | | | | on the home page. |
| Header | | 4 | Site | 1 | Content | 7 | | | | Default/ | | Drop- | | | Informaitonal only. No |
| | | | Config | | | | | | | Custom | | down | | | impact on ATG |
| Footer | | 4 | Site | 1 | Content | 8 | | | | Default/ | | Drop- | | | Informaitonal only. No |
| | | | Config | | | | | | | Custom | | down | | | impact on ATG |
| Default_ | Default_ | 4 | Site | 1 | Content | 9 | Search | Y | | 1. Margin | Margin $ | Drop- | | only | This is to define the |
| client_ | client_ | | Config | | | | | | | $ | | down | | allow | default sort criteria to be |
| search_sort | search_ | | | | | | | | | 2. | | | | one to | followed in endeca. |
| | sort | | | | | | | | | Relevance | | | | be | For price sorts, use |
| | | | | | | | | | | (search | | | | selected | itemsell price only (so if, |
| | | | | | | | | | | listing pg | | | | | dellsell that includes all |
| | | | | | | | | | | only) | | | | | components, if item sell |
| | | | | | | | | | | 3. Alpha | | | | | it includes all but tax |
| | | | | | | | | | | (A-Z) | | | | | components and if |
| | | | | | | | | | | 4. Alpha | | | | | standard it's itme price |
| | | | | | | | | | | (Z-A) | | | | | only). For Alpha use |
| | | | | | | | | | | 5. Price | | | | | item “title” or “short |
| | | | | | | | | | | (Low to | | | | | name” |
| | | | | | | | | | | High) | | | | | |
| | | | | | | | | | | 6. Price | | | | | |
| | | | | | | | | | | (High to | | | | | |
| | | | | | | | | | | Low) | | | | | |
| | | | | | | | | | | 7. Best | | | | | |
| | | | | | | | | | | Sellers | | | | | |
| | | | | | | | | | | 8. Highest | | | | | |
| | | | | | | | | | | Rated | | | | | |
| | | | | | | | | | | 9. Newest | | | | | |
| Pax_sort_ | Pax Sort | 4 | Site | 1 | Content | 10 | Search | | | 1. | all 8 | Drop- | | multiple | This attributes decides |
| options | Options | | Config | | | | | | | Relevance | default | down | | allowed | PAX sort options given |
| | | | | | | | | | | (search | | | | | in drop down list on site. |
| | | | | | | | | | | listing pg | | | | | This is to define the |
| | | | | | | | | | | only) | | | | | default sort criteria to be |
| | | | | | | | | | | 2. Alpha | | | | | followed in endeca. |
| | | | | | | | | | | (A-Z) | | | | | For price sorts, use |
| | | | | | | | | | | 3. Alpha | | | | | itemsell price only (so if, |
| | | | | | | | | | | (Z-A) | | | | | dellsell that includes all |
| | | | | | | | | | | 4. Price | | | | | components, if item sell |
| | | | | | | | | | | (Low to | | | | | it includes all but tax |
| | | | | | | | | | | High) | | | | | components and if |
| | | | | | | | | | | 5. Price | | | | | standard it's itme price |
| | | | | | | | | | | (High to | | | | | only). For Alpha use |
| | | | | | | | | | | Low) | | | | | item “title” or “short |
| | | | | | | | | | | 6. Best | | | | | name” |
| | | | | | | | | | | Sellers | | | | | |
| | | | | | | | | | | 7. Highest | | | | | |
| | | | | | | | | | | Rated | | | | | |
| | | | | | | | | | | 8. Newest | | | | | |
| Client | Client | 4 | Site | 1 | Content | 11 | | | | | | Textbox | | | Will be used in endeca |
| margin | margin | | Config | | | | | | | | | | | | for boost and bury |
| boost % | boost % | | | | | | | | | | | | | | |
| Search | Search | 4 | Site | 1 | Content | 11 | | Y | | 1) Price | Price | Drop- | | | Low, high and search |
| | | | Config | | | | | | | From To | From To | down | | | boxes to be rendered |
| | | | | | | | | | | and Key | and | | | | based on this attribute |
| | | | | | | | | | | word | Keyword | | | | on header. If the option |
| | | | | | | | | | | 2) | | | | | selected is Price From |
| | | | | | | | | | | keyword | | | | | To and Key word then |
| | | | | | | | | | | only | | | | | system displays low, |
| | | | | | | | | | | 3) Price | | | | | high and search box in |
| | | | | | | | | | | from to | | | | | header. |
| | | | | | | | | | | only | | | | | If the option selected is |
| | | | | | | | | | | 4) Other | | | | | keyword only then |
| | | | | | | | | | | 5) None | | | | | system displays only |
| | | | | | | | | | | | | | | | search keyword box in |
| | | | | | | | | | | | | | | | the header |
| | | | | | | | | | | | | | | | If the option selected is |
| | | | | | | | | | | | | | | | Price from to only then |
| | | | | | | | | | | | | | | | system displays only |
| | | | | | | | | | | | | | | | low and high fields in |
| | | | | | | | | | | | | | | | the header |
| Client | Client | 4 | Site | 1 | Content | 12 | | | | | | Textbox | | | Will be used in endeca |
| margin | margin | | Config | | | | | | | | | | | | for boost and bury |
| boost $ | boost $ | | | | | | | | | | | | | | |
| New_item_ | # Days to | 4 | Site | 1 | Content | 13 | Browse & | Y | 3 | 1-999 | 60 | Textbox | | | This attributes decides |
| nbr_days | Show Item | | Config | | | | Shop; | | | | | | | | the number of days a |
| | is New | | | | | | | | | | | | | | new item can be |
| | | | | | | | | | | | | | | | displayed with new icon |
| | | | | | | | | | | | | | | | on the site |
| Home Page | | 4 | Site | 2 | Home | 1 | | | | | | Textbox | | | Informational only. No |
| Notes | | | Config | | Page | | | | | | | | | | impact on ATG site |
| AUTHEN- | Authen- | 4 | Site | 2 | Home | 2 | Account | | | | | Listbox | | only | Need to display the |
| TICATED_ | ticated | | Config | | Page | | Management | | | | | | | allow | points balance welcome |
| Welcome_ | Welcome | | | | | | | | | | | | | one to | message on the site by |
| message | Message | | | | | | | | | | | | | be | picking the text from this |
| | | | | | | | | | | | | | | selected | attribute of user is |
| | | | | | | | | | | | | | | | known/authenticated |
| | | | | | | | | | | | | | | | and a message exists. If |
| | | | | | | | | | | | | | | | blank, show nothing |
| Visitor_ | Vistor | 4 | Site | 2 | Home | 3 | Account | | | | | Listbox | | only | Need to display the |
| Welcome_ | Welcome | | Config | | Page | | Management | | | | | | | allow | visitor's welcome |
| message | Message | | | | | | | | | | | | | one to | message on the site by |
| | | | | | | | | | | | | | | be | picking the text from this |
| | | | | | | | | | | | | | | selected | attribute |
| Home | | 4 | Site | 2 | Home | 4 | | Y | | DEFAULT: | DEFAULT | Drop- | | | Informational only. No |
| Hero | | | Config | | Page | | | | | CUSTOM; | | down | | | impact on ATG site |
| Slot | | | | | | | | | | NONE | | | | | |
| Home | | 4 | Site | 2 | Home | 5 | | Y | | DEFAULT: | DEFAULT | Drop- | | | Informational only. No |
| Vertical | | | Config | | Page | | | | | CUSTOM; | | down | | | impact on ATG site |
| Carousel | | | | | | | | | | NONE | | | | | |
| Home | | 4 | Site | 2 | Home | 6 | | Y | | DEFAULT: | DEFAULT | Drop- | | | Informational only. No |
| promo | | | Config | | Page | | | | | CUSTOM; | | down | | | impact on ATG site |
| strip 1 | | | | | | | | | | NONE | | | | | |
| Home | | 4 | Site | 2 | Home | 7 | | Y | | DEFAULT: | DEFAULT | Drop- | | | Informational only. No |
| promo | | | Config | | Page | | | | | CUSTOM; | | down | | | impact on ATG site |
| strip 2 | | | | | | | | | | NONE | | | | | |
| Home | | 4 | Site | 2 | Home | 8 | | Y | | DEFAULT: | DEFAULT | Drop- | | | Informational only. No |
| Horizontal | | | Config | | Page | | | | | CUSTOM; | | down | | | impact on ATG site |
| Carousel | | | | | | | | | | NONE | | | | | |
| Home | | 4 | Site | 2 | Home | 9 | | Y | | DEFAULT: | DEFAULT | Drop- | | | Informational only. No |
| Bottom | | | Config | | Page | | | | | CUSTOM; | | down | | | impact on ATG site |
| Promo | | | | | | | | | | NONE | | | | | |
| Home | | 4 | Site | 2 | Home | 10 | | Y | | DEFAULT: | DEFAULT | Drop- | | | Informational only. No |
| Vertical Nav | | | Config | | Page | | | | | CUSTOM; | | down | | | impact on ATG site |
| | | | | | | | | | | NONE | | | | | |
| Reviews | Show | 4 | Site | 2 | Content | 12 | Browse & | Y | | No | Stars & | Drop- | | | This attributes decides |
| | Reviews | | Config | | | | Shop | | | Reviews; | Comments | down | | | whether to show |
| | | | | | | | | | | Stars | | | | | reviews or not on the |
| | | | | | | | | | | Only; | | | | | site and if so will only |
| | | | | | | | | | | Stars & | | | | | stars show or also |
| | | | | | | | | | | Comments | | | | | comments |
| Gift_Wrap_ | Gift Wrap | 4 | Site | 2 | Content | 13 | Browse & | Y | | | | Listbox | | Allow | This attributes holds the |
| Choices | Choices | | Config | | | | Shop | | | | | | | multiple | values for gift wrap |
| | | | | | | | | | | | | | | | paper choices. If blank |
| | | | | | | | | | | | | | | | don't show giftwrap link |
| | | | | | | | | | | | | | | | on the shopping cart |
| Punchout | Punchout | 4 | Site | 2 | Content | 14 | Browse & | Y | 1 | Y/N | Y | Radio | | | Punch out will be |
| item | Item | | Config | | | | Shop | | | | | button | | | “items”. If this is “Y” |
| transition | Transition | | | | | | | | | | | | | | then when pax clicks |
| | | | | | | | | | | | | | | | thumbnail of item(from |
| | | | | | | | | | | | | | | | main navigation or |
| | | | | | | | | | | | | | | | search results page) it |
| | | | | | | | | | | | | | | | will take to item detail |
| | | | | | | | | | | | | | | | page and from there |
| | | | | | | | | | | | | | | | pax clicks to link over to |
| | | | | | | | | | | | | | | | 3rd party. If no, click of |
| | | | | | | | | | | | | | | | thumbnail image will |
| | | | | | | | | | | | | | | | take to 3rd party |
| | | | | | | | | | | | | | | | provider |
| | | | | | | | | | | | | | | | The same flag will be |
| | | | | | | | | | | | | | | | used for ABS media |
| | | | | | | | | | | | | | | | conversion redirection |
| | | | | | | | | | | | | | | | too |
| Promo | Promo | 4 | Site | 2 | Content | 15 | | N | 1 | Y/N | | Radio | | | Informational only |
| Landing | Landing | | Config | | | | | | | | | button | | | |
| Supp Pay | | 4 | Site | 2 | Content | 16 | | | | | | Drop- | | | System has to display |
| Header | | | Config | | | | | | | | | down | | | the supplemental |
| | | | | | | | | | | | | | | | header message in the |
| | | | | | | | | | | | | | | | header page based on |
| | | | | | | | | | | | | | | | this message |
| Contact | Contact Us | 4 | Site | 3 | Button | 1 | Browse & | N | | | | Textbox | | | Holds the Contact us |
| Us | | | Config | | Links | | Shop | | | | | | | | page URL |
| Help/FAQ | Help Page | 4 | Site | 3 | Button | 2 | Browse & | N | | | | Textbox | | | Holds the FAQ page |
| | Strategy | | Config | | Links | | Shop | | | | | | | | URL |
| Allow | Allow | 4 | Site | 3 | Button | 3 | Account | N | 1 | Y/N | | Radio | | | If Y show WL link in |
| Wishlist | Wishlist | | Config | | Links | | Management | | | | | button | | | header; else if N do not |
| | | | | | | | | | | | | | | | shown. |
| wishlist_ | Allow | 4 | Site | 3 | Button | 4 | Account | Y | 1 | Y/N | Y | Radio | | | If Y show WL widget in |
| widget | Wishlist | | Config | | Links | | Management | | | | | button | | | header; else if N do not |
| | Widget | | | | | | | | | | | | | | shown. Can only be Y if |
| | | | | | | | | | | | | | | | Allow WL is Y |
| Statement | Show | 4 | Site | 3 | Button | 5 | Account | N | 1 | Y/N | | Radio | | | Controls whether or not |
| | Statement | | Config | | Links | | Management | | | | | button | | | to show the statement |
| | | | | | | | | | | | | | | | link in header and my |
| | | | | | | | | | | | | | | | account history tab in |
| | | | | | | | | | | | | | | | my account page |
| Mini Cart | Mini Cart | 4 | Site | 3 | Button | 6 | | Y | 1 | Y/N | Y | Radio | | | IF Y show mini cart in |
| | | | Config | | Links | | | | | | | button | | | header else if N do not |
| | | | | | | | | | | | | | | | show |
| Category | Category | 4 | Site | 4 | Category | 1 | Informa- | Y | | | | Textbox | | | Informational only |
| Landing | Landing | | Config | | Landing | | tional | | | | | | | | |
| Notes | Notes | | | | Page | | only | | | | | | | | |
| Category | Category | 4 | Site | 4 | Category | 2 | Informa- | Y | | DEFAULT; | DEFAULT | Drop- | | | Informational only |
| Small | Small | | Config | | Landing | | tional | | | CUSTOM; | | down | | | |
| Promos | Promos | | | | Page | | only | | | NONE | | | | | |
| Category | Category | 4 | Site | 4 | Category | 3 | Informa- | Y | | DEFAULT; | DEFAULT | Drop- | | | Informational only |
| Hero Slot | Hero | | Config | | Landing | | tional | | | CUSTOM; | | down | | | |
| | Slot | | | | Page | | only | | | NONE | | | | | |
| Category | Category | 4 | Site | 4 | Category | 4 | Informa- | Y | | DEFAULT; | DEFAULT | Drop- | | | Informational only |
| Recom- | Recom- | | Config | | Landing | | tional | | | CUSTOM; | | down | | | |
| mendations | mendations | | | | Page | | only | | | NONE | | | | | |
| Category | Category | 4 | Site | 4 | Category | 5 | Informa- | Y | | DEFAULT; | DEFAULT | Drop- | | | Informational only |
| Side | Side | | Config | | Landing | | tional | | | CUSTOM; | | down | | | |
| Promo | Promo | | | | Page | | only | | | NONE | | | | | |
| Category | Category | 4 | Site | 4 | Category | 6 | Informa- | Y | | DEFAULT; | DEFAULT | Drop- | | | Informational only |
| Bottom | Bottom | | Config | | Landing | | tional | | | CUSTOM; | | down | | | |
| Promo | Promo | | | | Page | | only | | | NONE | | | | | |
| Cart Type | Cart Type | 4 | Site | 5 | Checkout | 7 | | Y | | DEFAULT; | DEFAULT | Drop- | | | Informationaly only |
| | | | Config | | | | | | | CUSTOM; | | down | | | |
| | | | | | | | | | | NONE | | | | | |
| Checkout | Checkout | 4 | Site | 5 | Checkout | 8 | Checkout | | | | | Drop- | | | This attribute decides |
| Type | Type | | Config | | | | | | | | | down | | | the type of checkout. |
| | | | | | | | | | | | | | | | Holds values like |
| | | | | | | | | | | | | | | | Standard, Gaming and |
| | | | | | | | | | | | | | | | will drive the |
| | | | | | | | | | | | | | | | functionality for ckout |
| Profile | Profile | 4 | Site | 6 | Account | 1 | Account | | | | | Listbox | | Allow | This attribute holds the |
| attribute | Attribute | | Config | | | | Management | | | | | | | multiple | values of profile |
| choices | Choices | | | | | | | | | | | | | | attribute choices like |
| | | | | | | | | | | | | | | | Income, Education etc. |
| Display | | 4 | Site | 6 | Account | 2 | Acct Mgt | Y | 1 | Y/N | Y | Radio | | | Acct |
| Favorite | | | Config | | | | | | | | | Button | | | |
| Categories | | | | | | | | | | | | | | | |
| Interests | | 4 | Site | 6 | Account | 3 | Acct Mgt | | | | | Listbox | | Multiple | Need to display the |
| | | | Config | | | | | | | | | | | | interests on my account |
| | | | | | | | | | | | | | | | page picking the values |
| | | | | | | | | | | | | | | | of this attribute |
| Endeca | | 5 | Site | 5 | Home | 3 | Homepage | Y | | Hilton | | Drop- | | | Endeca uses this |
| Segment | | | Config | | Page | | | | | Standard | | down | | | attibute to identify the |
| Type | | | | | | | | | | Marriott | | | | | header associated with |
| | | | | | | | | | | Regions | | | | | CCU |
| | | | | | | | | | | Rapids | | | | | |

What is claimed is:

1. A system, comprising:
a business rules database storage device configured to store a plurality of business rules;
an attribute database storage device configured to store a plurality of client configuration unit (CCU) attributes;
a parameter database storage device configured to store a plurality of participant parameters;
a CCU program generator module configured to generate a CCU program for a plurality of participants, each CCU program defined by an attribute subset of the CCU attributes and defined by a business rules subset of the business rules, wherein the plurality of CCU programs each have different attributes subsets, and wherein the plurality of CCU programs each have different business rules subsets;
a participant user interface (PUI) module configured to identify a plurality of participant user devices each associated with one of the plurality of participants; and
a processor configured to:
execute the PUI module to associate each of the plurality of participant user devices with one of the plurality of participants of each CCU program based on the plurality of participant parameters stored in the parameter database storage device;
execute the CCU program generator module to generate each CCU program, wherein each generated CCU program is based on:
the CCU attributes subset, and
the business rules subset,
execute the CCU program generator module to customize each generated CCU program to one of the plurality of participants thereof, wherein each customized CCU program is further defined by the participant parameters of the identified participant user device; and
execute the PUI module to provide each identified participant user device access to a plurality of e-commerce websites of an e-commerce system via the customized CCU program generated for the participant associated therewith.

2. The system of claim 1, further comprising a personalization, marketing, and targeting (P/M/T) rules database storage device configured to store a plurality of P/M/T rules each associated with at least one of the participant user devices, wherein the processor is configured to execute the CCU program generator module to customize each generated CCU program to one of the plurality of participants thereof, wherein each customized CCU program is further defined by a P/M/T rules subset of the P/M/T rules of the associated participant user device.

3. The system of claim 2, wherein the processor is configured to execute the PUI module to provide each identified participant user device access to the plurality of e-commerce websites via the customized CCU program generated for the participant associated therewith based on the P/M/T rules subset.

4. The system of claim 2, further comprising an administrator user interface (AUI) module configured to define each CCU program in response to administrator input via an administrator user device, each CCU program defined by the attribute subset comprising CCU attributes selected in response to the administrator input, each CCU program defined by the business rules subset comprising business rules selected in response to the administrator input, wherein the processor is configured to execute the CCU program generator module to define each CCU program in response to the administrator input received via the AUI.

5. The system of claim 4, wherein the AUI module is further configured to implement the P/M/T rules in response to receiving administrator input via the administrator user device.

6. The system of claim 4, wherein the AUI module is further configured to implement inclusion and exclusion rules stored in an inclusion/exclusion rules database storage device to control, in response to receiving administrator input via the administrator user device, the plurality of e-commerce websites available to participant user devices via their generated CCU programs.

7. The system of claim 6, wherein the CCU program generator module comprises an inclusion/exclusion rules engine for implementing the inclusion and exclusion rules stored in the inclusion/exclusion rules database storage device.

8. The system of claim 4,
wherein the plurality of participant parameters includes a participant parameter indicative of a point balance value associated with an account of each participant,
wherein the attribute subset includes a CCU attribute directed to sending of a promotional component of the e-commerce websites to participant user devices,
wherein the processor is configured to execute the CCU program generator module to customize each generated CCU program based on the participant parameter indicative of the point balance value and based on the CCU attribute directed to sending of the e-commerce website promotional component, and
wherein the processor is configured to execute the PUI module to provide identified participant user devices access to the plurality of e-commerce websites including the e-commerce website promotional component when the identified participant user devices are associated with the participant parameter indicative of the point balance value being greater than a threshold value received via the AUI module.

9. The system of claim 2, wherein the CCU program generator module comprises a P/M/T rules engine for implementing the P/M/T rules subset as a function of the attributes subset of the CCU program and as a function of the participant parameters of the CCU program.

10. The system of claim 2,
wherein the plurality of participant parameters includes a participant parameter directed to a particular product category,
wherein the attribute subset includes a CCU attribute directed to sending of a promotional component of the e-commerce websites to participant user devices,
wherein the processor is configured to execute the CCU program generator module to customize each generated CCU program based on the participant parameter directed to the particular product category and based on the CCU attribute directed to sending of the e-commerce website promotional component, and
wherein the processor is configured to execute the PUI module to provide identified participant user devices access to the plurality of e-commerce websites including the e-commerce website promotional component directed to the particular product category when the identified participant user devices are associated with the participant parameter directed to the particular product category and the CCU attribute directed to sending of the e-commerce website promotional component.

11. The system of claim 1, wherein the CCU program generator module comprises a business rules engine for implementing the business rules stored in the business rules database storage device.

12. A computer-implemented method, comprising:
storing a plurality of business rules in a business rules database storage device;
storing a plurality of client configuration unit (CCU) attributes in an attribute database storage device;
storing a plurality of participant parameters in a parameter database storage device;
storing a CCU program generator module on a memory storage device;
storing a participant user interface (PUI) module on the memory storage device;
identifying a plurality of participant user devices each associated with one of a plurality of participants by executing the PUI module on a processor, wherein the processor is connected to the memory storage device;
associating each of the plurality of participant user devices with one of the plurality of participants based on the plurality of participant parameters by executing the PUI module on the processor, wherein the processor is further connected to the parameter database storage device;
defining a CCU program for the plurality of participants by an attribute subset of the CCU attributes and a business rules subset of the business rules by executing a CCU program generator module on the processor, wherein the processor is further connected to the business rules database storage device and the attribute database storage device;
generating each CCU program based on the CCU attributes subset and the business rules subset by executing the CCU program generator module on the processor;
customizing each generated CCU program to one of the plurality of participants by executing the CCU program generator module on the processor, wherein each customized CCU program is further defined by the participant parameters of the participant; and
providing each participant user device access to a plurality of e-commerce websites of an e-commerce system via the customized CCU program generated for the participant associated therewith by executing the PUI module on the processor.

13. The method of claim 12, further comprising:
storing a plurality of personalization, marketing, and/or targeting (P/M/T) rules in a P/M/T rules database storage device, wherein each P/M/T rule is associated with at least one of the participant user devices, wherein the processor is further connected to the P/M/T rules database storage device; and
customizing each generated CCU program to one of the plurality of participants by executing the CCU program generator module on the processor, wherein each customized CCU program is further defined by a P/M/T rules subset of the P/M/T rules of the associated participant user device.

14. The method of claim 13, further comprising providing each participant user device access to the plurality of e-commerce websites via the customized CCU program generated for the participant associated therewith based on the P/M/T rules subset by executing the PUI module on the processor.

15. The method of claim 13, further comprising:
storing an administrator user interface (AUI) module on the memory storage device;
selecting CCU attributes comprising the attribute subset in response to administrator input via an administrator user device by executing the AUI module on the processor;
selecting business rules comprising the business rules subset in response to the administrator input by executing the AUI module on the processor; and
defining each CCU program in response to the administrator input by executing the AUI module on the processor.

16. The method of claim 15, further comprising implementing the P/M/T rules in response to receiving the administrator input by executing the AUI module on the processor.

17. The method of claim 15, further comprising:
storing a plurality of inclusion and/or exclusion rules in an inclusion/exclusion rules database storage device;
implementing the inclusion and/or exclusion rules by executing an inclusion/exclusion rules engine comprising the CCU program generator module on the processor; and
controlling the plurality of e-commerce websites available to participant user devices via their generated CCU programs by executing the AUI module on the processor to implement the inclusion and/or exclusion rules in response to receiving the administrator input.

18. The method of claim 15, further comprising:
storing a participant parameter indicative of a point balance value associated with an account of each participant in the parameter database storage device;
storing a CCU attribute directed to sending of a promotional component of the e-commerce websites to participant user devices in the attribute database storage device;
customizing each generated CCU program based on the participant parameter indicative of the point balance value and based on the CCU attribute directed to sending of the e-commerce website promotional component by executing the CCU program generator module on the processor;
receiving a threshold value via the administrator user device by executing the AUI module on the processor; and
providing participant user devices access to the plurality of e-commerce websites including the e-commerce website promotional component when the participant user devices are associated with the participant parameter indicative of the point balance value being greater than the threshold value by executing the PUI module on the processor.

19. The method of claim 13, further comprising implementing the P/M/T rules subset as a function of the attributes subset of the CCU program and as a function of the participant parameters of the CCU program by executing a P/M/T rules engine comprising the CCU program generator module on the processor.

20. The method of claim 13, further comprising:
storing a participant parameter directed to a particular product category in the parameter database storage device;
storing a CCU attribute directed to sending of a promotional component of the e-commerce websites to participant user devices in the attribute database storage device;
customizing each generated CCU program based on the participant parameter directed to the particular product category and based on the CCU attribute directed to sending of the e-commerce website promotional component by executing the CCU program generator module on the processor; and
providing participant user devices access to the plurality of e-commerce websites including the e-commerce website promotional component directed to the particular product category when the participant user devices are associated with the participant parameter directed to the particular product category and the CCU attribute directed to sending of the e-commerce website promotional component.
